(19) United States
(12) Patent Application Publication
(10) Pub. No.: US 2024/0184904 A1
(43) Pub. Date: Jun. 6, 2024

(54) Method and System for Managing at Least One Unique Data Record

(71) Applicants: Fraunhofer-Gesellschaft zur Förderung der angewandten Forschung e.V., München (DE); Active Image GmbH, Berlin (DE)

(72) Inventors: Christopher Krauß, Berlin (DE); Stephan Steglich, Berlin (DE); André Paul, Berlin (DE); Henning Lohner, Berlin (DE)

(21) Appl. No.: 18/284,889

(22) PCT Filed: Mar. 30, 2022
(86) PCT No.: PCT/EP2022/058438

§ 371 Date: Sep. 29, 2023

(30) Foreign Application Priority Data
Mar. 30, 2021 (DE) 10 2021 108 109.2

(51) Int. Cl. G06F 21/62; G06F 21/10; G06F 21/60

(52) U.S. Cl. CPC G06F 21/6209; G06F 21/10; G06F 21/602

(57) ABSTRACT

Provided is a method for managing at least one unique data record, in particular a digital work of art, at a unique data record platform including the following steps receiving at the unique data record platform a creation request comprising raw data; creating, at the unique data record platform, the unique data record based on the raw data; verifying the uniqueness of the unique data record within at least a part of a unique data record ecosystem including the unique data record platform and/or at least one module associated with it; integrating, at the unique data record platform, the unique data record into the unique data record ecosystem on the basis of the uniqueness verification process; and automatically limiting access to the raw data used for creating the unique data record in the unique data record platform.

### CROSS-REFERENCE TO RELATED APPLICATIONS

This application is the United States national phase of International Patent Application Number PCT/EP2022/058438, filed Mar. 30, 2022, and claims priority to German Patent Application Number 10 2021 108 109.2, filed Mar. 30, 2021, the disclosures of which are hereby incorporated by reference in their entireties.

### BACKGROUND OF THE INVENTION

### Field of the Invention

In contrast to the analog world, in the digital world there is no real uniqueness as such, as all bits and bytes can be copied and replicated which results in equal characteristics of the respective digital media. There is no way to differentiate a copy from the original.

### Description of Related Art

In the present context, digital uniqueness means creating the impression of “uniqueness” by providing appropriate means to clearly and tamper-proof describe and identify a digital media as the original or a legitimate copy as well as to clearly identify illegitimate copies. Tamper-proof in this context can imply that raw data is accessible to a user, while the user can be sure that the raw data or some data derived from the raw data has not been modified as a whole or at least in parts in an unauthorized form.

Existing methods to create the impression of uniqueness such as Digital Rights Management (DRM) Systems or so-called Technological Protection Measures allow the restriction of the use of digital assets, including media files, in trusted environments, which usually requires licensing and certification of the respective (DRM) provider. In the existing methods, the secured digital media is extended according to the respective DRM policies, specifying exactly the allowed use of media play back, for instance, by using functions such as fast forward skip, or recording and storing of the media. This usually requires a strong encryption of the media file so that the given policies cannot be bypassed and an according key handling to allow the decryption of the media in trusted environments. The primary goal is to prevent unprotected intellectual property from being copied freely (especially for media files such as video and ebooks) and to prevent modification of the asset (anti-tampering), especially for software.

There are a number of commercially available and widely used systems such as Adobe DRM, Microsoft Playready, Google Widewine, Apple Fairplay, Marlin DRM, etc. addressing these issues.

These principles are nowadays also applied for the distribution of software such as mobile apps via app stores to prevent the modification of the software packages (to prevent misuse, e.g., including malicious code). Electronic signature certification of documents (primarily text documents) is realized by adding a digital signature using a Public Key Infrastructure (PKI) with corresponding certification authorities such as for example DocuSign. For verification the certificate must be evaluated and the file must be directly accessed.

### SUMMARY OF THE INVENTION

Therefore, efficient methods and systems to handle unique digital data are required.

This issue is addressed by a method for managing at least one unique data record (UDR) with features as described herein, a method for validating a presentation of a UDR with features as described herein, a system for managing at least one UDR with features as described herein, a system for validating a presentation of an UDR with features as described herein and a computer program product with features as described herein.

The claimed solution comprises a method for managing at least one UDR, in particular a digital work of art, at a unique data record platform (UDRP) comprising the steps of receiving at the UDRP a creation request comprising raw data (e.g. an actual media file that e.g. an artist created and which is thus considered to be a valuable asset); creating, at the UDRP, the UDR based on the raw data; verifying the uniqueness of the UDR within at least a part of a unique data record ecosystem (UDRE) comprising the UDRP and/or at least one module associated with it; integrating, at the UDRP, the UDR into the UDRE on the basis of the uniqueness verification process; and automatically limiting access to the raw data (e.g. deleting the raw data or make it unreadable) used for creating the UDR in the UDRP.

The claimed solution goes beyond basic principles of Digital Rights Management (DRM) systems relating to the safe storage (encryption, access control) and presentation of digital media to create the impression of uniqueness. After a digital media has once been uploaded to the UDRP, it becomes a UDR and it will in one embodiment never leave the UDRP, at least not in unencrypted or unsealed form.

For a presentation of the UDR, e.g. a public display of the artwork represented by the UDR, digital copies of the UDR with embedded seal data will be created and provided by the UDRP. The seal data contains or references the necessary legitimization features (or a token as representation of those features) for a legitimate presentation of this UDR. In one embodiment UDRs can leave the UDRP, e.g. as a sealed UDR for a public presentation or as an encrypted UDR in a safe storage.

Moreover, an embodiment also enables the storage of encrypted UDRs via untrusted or unsecured entities (e.g., public storage or the local files system). Thus, third parties can host encrypted UDRs without being able to present them.

For the presentation of the UDR, the approach presented here does, in one embodiment, not require a trusted environment and direct access to the original raw data (e.g. the original media files). Instead it makes it possible for—in principle—any device to access (display) the UDR (although sealed).

In general, for each presentation of the UDR, seal data is embedded into (in particular a copy of) the UDR. On the other hand, for validating the legitimacy of a presented UDR, seal data is extracted from the presented UDR and the validation process is based on the extracted seal data.

Based on the presented seal the actual license can be verified, i.e. similar to seals for physical objects (such as for products) the system can prove, in some embodiments, the integrity of the seals (whether it is broken or intact) and/or the validity of the seals (e.g. by checking against a temporal or local condition) by verifying the embedded token (which can be made invalid by the UDRP, e.g., when transferring ownership or any other change of the license and in this way invalidating the seal).

The seal data may for instance be embedded as a visual seal, e.g. via a QR code, or the seal data may be embedded as a seal which is (nearly) non-perceptible by humans, e.g. seal data embedded as watermark or via so called “out-of-band” signals (such as via Bluetooth Low Energy broadcasting)).

The process of embedding and/or of extracting seal data may make use of methods known from steganography. However, even though the process of embedding the seal data may, in some embodiments, be based on processes known from steganography solutions, the purpose of embedding the seal data in the present context differs from the general goal of steganography, the latter being the transmission of secrets. Instead, the embedding of seal data into the UDR in the present context makes it possible to validate the legitimacy of a presentation of sealed UDRs.

The UDR is managed within the UDRE, which may comprise one or more components e.g. for managing, storing and/or presenting UDRs.

The core of the UDRE comprises at least one UDRP for managing the UDR within the UDRE. The UDRP can comprise a computer system as a standalone system or a network of computer systems. The UDRP can at least partially be realized as a software system.

The UDRP creates the UDR on the basis of the raw data comprised in the creation request received at the UDRP. The raw data may refer to an actual media file that e.g. an artist created. In general, the raw data is considered the most valuable asset of the UDR and therefore needs to be securely handled.

The creation of the UDR by the UDRP may be based on processing, in particular on extracting data from the raw data and/or on modifying the raw data. In particular, the creation of the UDR may involve transforming the raw data into a specific data format, in particular, modifying the data format of the raw data. The process of creating the UDR may also involve compressing the raw data or generating specific files from the raw data.

The creation request may comprise additional data, in particular metadata associated with the raw data. The additional data, in particular the metadata may be used by the UDRP in the creation of the UDR. Thus, the creation of the UDR may be based on the metadata in the request data.

The metadata associated with the raw may e.g. comprise the name of the creator of the raw data, or the name of the owner of the UDR, the date of the creation of the raw data, a description on how the raw data was created, and/or the name of the country where the raw data was created. Additionally or alternatively the metadata may comprise technical specifications needed at the UDRP to create the UDR.

The metadata associated with the raw data of the UDR may, at least partially, be comprised in the UDR after its creation.

The UDRP verifies the uniqueness of the UDR within at least a part of the UDRE, e.g. by comparing the UDR with other UDRs already present in the UDRE (e.g. stored on a storage media within at least one part UDRE). For instance, the comparison may be based on the content, e.g. on image content of the UDRs and/or on metadata (e.g. the name of the creator, an exhibition location, date of creation) associated with the UDRs. The comparison may be based on the UDRs or on data representing the content of the UDRs, via fingerprints of the UDRs.

The uniqueness verification may at least in part be based on instructions contained in the creation request. For instance, the creation request may contain an indication of a certainty level that the uniqueness verification performed by the UDRP should be based on. The certainty level may indicate what procedure for verifying the uniqueness of the UDR is to be carried out, e.g. what algorithm the uniqueness verification is to be based on (e.g. on a similarity analysis based on hash values of the UDRs and/or based on raw data of the UDRs), what sensitivity the algorithm should have (e.g. at what value of a detected similarity does the algorithm result in non-uniqueness) or whether a human decision was involved in the process. Then, the uniqueness verification may be adjusted to comply with the certainty level indicated in the creation request. Additionally or alternatively, the uniqueness verification process may be based on or be initiated by instructions received from users or other components of the UDRE.

The UDRP integrates the UDR into the UDRE on the basis of the uniqueness verification process. For instance, the UDRP may integrate the UDR into the UDRE only if the uniqueness verification process was successfully executed, i.e. the uniqueness verification procedure delivered a result, and was positive, i.e. result of the procedure was that the UDR is unique. In other words, the UDRP may be arranged to only integrate the UDR when it is considered to be unique in the UDRE, or at least in part of the UDRE.

Finally, the UDRP automatically limits access to the raw data used for creating the UDR in the UDRP. The automatic process of limiting access to the raw data used for creating the UDR, also referred to as the raw data of the UDR, may involve rendering the raw data unreadable by the UDRP itself and/or by any other data-reading entity. In particular, the process of limiting access to the raw data may be achieved by modifying the raw data. The modification of the raw data may involve deleting the raw data, e.g. deleting the raw data from a local storage of the UDRP. In addition or alternatively, modifying the raw data may involve substantially) altering the raw data, in particular, altering the raw data or parts of it in a way that the raw data is not reconstructable from the altered raw data. Altering may comprise scrambling the raw data, e.g. in a random way.

Limiting access to the raw data may also be achieved by overwriting the raw data, fully or partially, e.g. by overwriting the raw data with random data. The process of limiting access to the raw data may additionally or alternatively involve changing the local directory of the raw data and therefore hinder detection of the raw data, e.g. in a specific (local) storage unit.

In general, the process of limiting access to the raw data hinders the readability of the raw data and/or the detectability of the raw data.

The raw data of the UDR is considered to be the most valuable asset associated with the UDR and is the data that needs to be protected and not be accessed by unauthorized users, systems or system components. The automatic limitation of access to the raw data (or of its derivative(s)) in the UDRP ensures that the raw data associated with the UDR is at most only temporally unrestrictedly accessible by the UDRP. The raw data of the UDR is e.g. considered as an original work of art and therefore needs to be securely handled.

In general, all processes executed by the UDRP which involve handling unencrypted UDR data, in particular handling data of the UDR which may be used for reconstructing or nearly reconstructing the raw data of the UDR, will involve the step of limiting access to the unencrypted UDR data.

The automatic limitation of access of vulnerable data, (also termed sensitive data) e.g. the unencrypted or raw data, of the UDR after every process executed by the UDRP ensures a secure handling of the UDR by the UDRP.

Additionally, the UDRP may process the UDR on the basis of condition data. The processing may follow the creation or integration of the UDR directly or the process may be interweaved with the process of creating or integrating the UDR. Alternatively, the process may be disconnected, in particular timewise, from the process of creating or integrating the UDR, for instance, a further processing of the UDR may be executed, a few hours or a few weeks or even years after the creation of the UDR.

The processing of the UDR and/or metadata associated with the UDR may be initiated by the UDRP itself and/or it may be initiated on the basis of processing request data received by the UDRP. The condition data on the basis of which the process is executed may be contained in the processing request data.

The processing request data may have been sent by a user and/or a computer system to the UDRP. The processing request data may specify how the UDR should be processed. Additionally or alternatively, the condition data may comprise data specifying in what way the UDRP should answer to the processing request data or one or more additional conditions to answer processing request data.

Additionally or alternatively, the condition data may provide additional data required by the UDRP to answer to the processing request data. The condition data may comprise data identifying the UDR that the processing request data relates to, e.g. by containing a unique identifier of the UDR.

The condition data may comprise a key, e.g. an external and/or an internal key, on the basis of which the UDRP encrypts the first subset of the UDR. In particular, the condition data may comprise data on the basis of which the UDRP may generate or reconstruct the key for the encryption of the UDR. For instance, the processing request data received by the UDRP may comprise data on the basis of which the UDRP generates the key.

The UDRP may process the UDR by encrypting at least a first subset of the UDR and thereby produce an encrypted UDR. The first subset of the UDR may comprise all data of the UDR or a proper subpart of it.

Additionally or alternatively, the processing comprises decrypting an encrypted UDR. The key used by the UDRP to decrypt the encrypted UDR may be comprised in the condition data or the key may be reconstructable based on the condition data.

Additionally or alternatively, the processing comprises transmitting the encrypted UDR to a storage module coupleable to the UDRP and/or retrieving the encrypted UDR from the storage module. An identifier of a particular storage unit of the storage module where the encrypted UDR is retrieved from or transmitted to may be inferable from the condition data. Alternatively, the UDRP may infer the identifier of the storage unit from other data contained in the processing request data or from other metadata associated with the UDR.

Additionally or alternatively, the processing comprises automatically limiting access, at the UDRP, to the UDR. In particular, the UDRP may automatically limit access to the unencrypted UDR or any locally stored unencrypted parts of the UDR.

The process of automatically limiting access to the UDR may be similar to limiting access to the raw data associated with the UDR. In particular, automatically limiting access to the UDR may be based on modifying the UDR, in particular on modifying an unencrypted subset of the UDR, where modifying may be based on overwriting, deleting, irreversibly alter, and/or scrambling the UDR, in particular the unencrypted UDR, or a subset of it.

Since, similar to the raw data associated with the UDR, the (unencrypted) UDR is potentially a valuable asset of the UDR data, a limitation of access to the (unencrypted) UDR, in particular an automatic limitation of access to the (unencrypted) UDR after every process, ensures a secure handling of the UDR by the UDRP.

Additionally or alternatively, the processing comprises embedding seal data into the UDR to produce a sealed UDR. In particular, the processing request data received at the UDRP may prompt the UDRP to generate seal data for a presentation of the UDR and embed the seal data into the UDR to produce a sealed UDR.

The seal data may be associated with a presentation of the UDR. For instance, the processing request data may comprise a presentation request, requesting the UDRP to present the (sealed) UDR in a particular location or on a particular device. Upon receiving the presentation request, the UDRP may generate the seal data to be embedded into the UDR. The embedding of the seal data may only affect a subset of the UDR, in particular, the UDR may be altered partially by the seal data embedding process.

The seal data may be generated based on information contained in the condition data on the basis of which the UDRP executes the embedding. In particular, the condition data on which the generation of the seal data is based on may be provided by a user sending the presentation request.

The seal data may reference legitimization features associated with the presentation of the UDR. The legitimization features may comprise one or more geo-locations and/or one or more time periods, e.g., indicating one or more locations at which the presentation of the UDR is legitimate and/or one or more periods during which the presentation of the UDR is legitimate. The legitimization features may be generated in the UDRP.

The condition data may indicate the type of seal data embedding to be used, e.g., producing a seal visibly attached to the presentation of the UDR such as a QR code or producing a seal that is hardly perceptible by humans such as a hidden hologram or a Bluetooth signal.

The embedding of the seal data may be based on manipulating at least a subset of UDR. The subset may be determined based on data of a specific frequency range or based on the content of the subset of the UDR. Embedding the seal data may be based on methods known from steganography.

The UDR may comprise image data. In case the UDR comprises image data, the embedding of the seal data may be based on manipulating pixel data, in particular pixel data of a specific frequency range and/or a specific color channel, of the image data.

For instance, the encoding of the seal data into the image data comprised in or derived from the UDR may be based on manipulating pixel data associated with spectral coefficients representing mid-range frequencies. Since changes in spectral coefficients of image data representing mid-range frequencies are difficult to perceive by the human eye, the manipulation of such may not be easily spotted by humans but at the same time readily detectable by computing devices with visual access.

Alternatively, or in addition, the pixel data to be manipulated in order to embed the seal data may be determined based on the image content. In particular, the subset of the UDR to be manipulated may be chosen dynamically.

The UDR may comprise audio data. In case the UDR comprises audio data, the embedding of the seal may be based on manipulating audio data of a specific frequency range. For instance, an inaudible frequency range, e.g. a frequency range inaudible by humans, may be manipulated.

The embedding of the seal into the UDR may comprise several steps and the embedding of the seal may require a preprocessing of a subset of the UDR.

Additionally or alternatively, the processing comprises transmitting the UDR, in particular the sealed UDR, to a presentation module comprising means to present, in particular to display, a presentation of the UDR.

The presentation module may comprise several presentation units (such as, e.g., a smartphone, a digital display, a sound system, or a 3-D printer), and the transmission of the (sealed) UDR to the presentation module may be addressed to a specific presentation unit of the presentation module.

The presentation of the (sealed) UDR may comprise a visually perceivable presentation such as an image, a projection, a video or an object produced by a 3-D printer. Additionally or alternatively, the presentation of the UDR may comprise an audibly perceivable presentation such as sounds or a piece of music.

The presentation module or a specific presentation unit of the presentation module that the sealed UDR is transmitted to may then present the UDR.

Additionally or alternatively, processing comprises the step of transmitting metadata, in particular transaction data, associated with the UDR to a registry module coupleable to the UDRP. The registry module may (automatically) store transaction data associated with the UDR. The transaction data may in particular comprise data associated with the processing of the UDR. For instance, the transaction data may comprise information on when the UDR was created, about the owner of the UDR, or where and/or when a presentation of the UDR was generated. The processing may also comprises retrieving metadata, in particular transaction data, associated with the UDR from the registry module.

In general, the UDRE may comprise a plurality of UDRPs and/or a plurality of modules, such as a plurality of storage modules, registration modules, and/or presentation modules.

The issues are also addressed by a method for validating, at a UDRP and/or at a validation application, a presentation of a UDR, in particular a digital work of art, comprising the steps of, receiving, at the UDRP and/or at the validation application, a validation request for validating the presentation of the UDR based on representation data of the presentation of the UDR and validating of the presentation of the UDR based on extracted seal data, in particular on legitimization features comprised in and/or referenced by the extracted seal data, extracted from the representation data.

The representation data may comprise and/or be generated on the basis of captured data, in particular digitally recorded data, of the presentation of the UDR. In particular, the representation data may comprise visually recorded data, in particular image or video data, of the presentation of the UDR. In addition or alternatively, the representation data may comprise audio data, in particular acoustically recorded audio data, of the presentation of the UDR.

The extracted seal data may be extracted at the UDRP, or alternatively, at a validation application. The validation application may be coupleable to the UDRP.

The validation of the presentation may be performed at least in part by comparing the extracted seal data with transaction data associated with the presentation of the UDR. In particular, the presentation transaction data associated with the presentation of the UDR may be retrieved from a registry module coupleable to the UDRP and/or to the validation application.

The process of validating the presentation of the UDR may involve checking whether the extracted seal data comprises an intact or a broken seal. In general, checking whether the seal is intact comprises checking whether the extracted seal data matches the originally embedded seal data which, in one embodiment, is saved in the registry module. In case of a match, the extracted seal is considered intact. Subsequently, legitimization features associated with the extracted seal data can be validated. In case the seal data can only be extracted partially or not at all, the seal is considered to be invalid.

In addition, the method may comprise the step of, at the UDRP, embedding seal data into the UDR to produce a sealed UDR and/or of transmitting the sealed UDR to a presentation module comprising means to present the UDR.

### BRIEF DESCRIPTION OF THE DRAWINGS

Exemplary embodiments of the solution are described in connection with the figures.

FIG. 1 shows schematically an embodiment of a unique data record platform (UDRP) in the context of several optional use cases.

FIG. 2 shows an embodiment of the unique data record ecosystem (UDRE).

FIG. 3 shows an exemplary embodiment of the UDRP.

FIG. 4 shows an exemplary process of the claimed solution and is a continuation of the embodiments described with reference to FIGS. 2 and 3.

FIG. 5 illustrates a version of the registry module of the UDRE that is realized with a blockchain.

FIG. 6 illustrates the process of creating the unique data record (UDR) and integrating the UDR into the UDRE.

FIG. 7 illustrates the process of presenting the UDR via a presentation module.

FIG. 8 illustrates the process of validating a presentation of the UDR.

FIG. 9 illustrates the process of retrieving a provenance of the UDR from a registry module.

FIG. 10 illustrates the process of transferring the ownership of the UDR.

FIG. 11 illustrates a sealed UDR as the result of embedding seal data into the UDR.

FIG. 12 illustrates the process of validating the presentation of the UDR 1 in the case where the presentation of the UDR 1 is based on image data.

### DESCRIPTION OF THE INVENTION

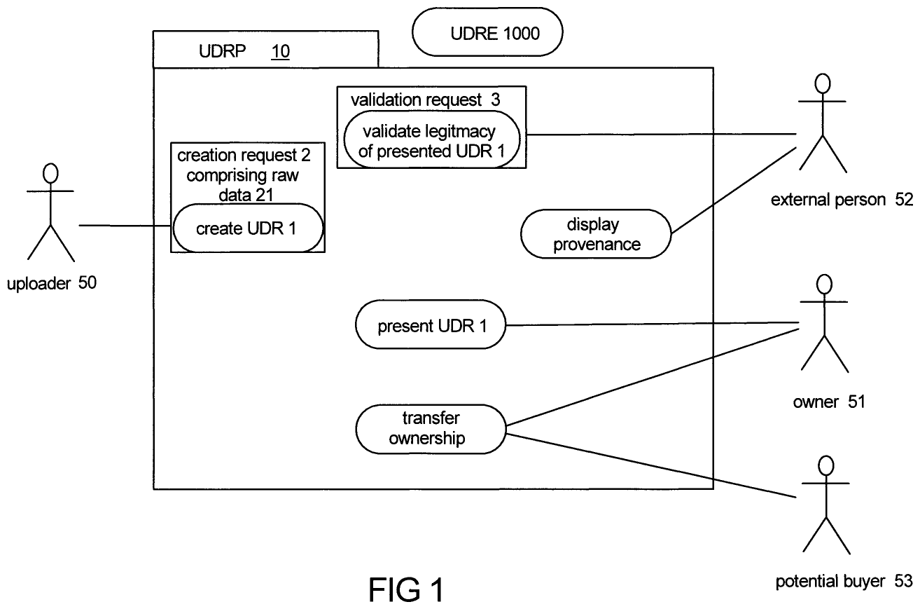

Before describing different embodiments, the general concept of a unique data record ecosystem 1000 (UDRE) is described here in particular in connection with FIG. 1.

The core of the UDRE 1000 is a unique data record platform (UDRP) 10, which is arranged to manage at least one unique data record (UDR) 1.

The UDRP 10 creates the UDR 1 based on raw data 21 comprised in a creation request 2 which is received by the UDRP 10. For instance, the creation request 2 may be sent to the UDRP 10 by an uploader 50, e.g. an artist who originally created the raw data 21 of the UDR 1.

The created UDR 1, in general, comprises vulnerable data, e.g. a data set modified from the raw data 21 but with the property that the raw data 21 can be recovered from the modified data set. The vulnerable data could also be termed as payload data.

Moreover, the UDR 1 may comprise metadata, such as the name of its uploader and/or artist, the date of its upload, etc.

The UDR 1, in particular the vulnerable data of the UDR 1, may represent a piece of art, like a visually perceivable image or video, and/or audibly perceivable data, like audio data representing sounds or a piece of music. Thus, in particular the vulnerable data of the UDR 1 should be protected and must not be accessible by third parties, at least not in unencrypted or unsealed form.

In general, the UDR 1 represents an object which can be represented fully or partially in digital form. For instance, the UDR 1 may comprise an image, a video, an animation, or any other digital media with a visual presentation. Additionally or alternatively, the UDR 1 can comprise a set of digital media (e.g., multiple images at the same time) or only parts of a digital media (e.g., just a particular view angle of a 360° video).

Likewise, the UDR 1 may comprise instructions to be carried out by a 3-D printer, instructions to operate a sound or light system, or any other system that can be operated by instructions in a digital form.

In general, the UDR 1 may fully or partially represent a piece of art that it is associated with, in the sense that it may contain data related to a piece of art which has a digitally representable component, but may itself not be fully representable in digital form. For instance, there might be a physical object related to the UDR 1 which is itself not representable in digital form.

After, before or while its creation, the UDRP 10 validates the uniqueness of the UDR 1 within at least a part of the UDRE 1000 and integrates it in the UDRE 1000 based on the result of the uniqueness verification process.

The notion of “uniqueness” here may refer to different types of uniqueness. For instance, the UDR 1 may be considered unique because of its unique content and/or based on its unique provenance. In detail:

The verification of uniqueness can in one embodiment be based on the content (such as image content or audio content) of the UDR 1, i.e. a UDR 1 is considered unique in the UDRE 1000 or at least a part of the UDRE 1000, in case there is no other UDR with the same content.

In addition or alternatively, the verification of uniqueness may be based on the metadata comprised in or associated with the respective UDRs. Consequently, the UDR 1 may gain its status of uniqueness by its specific provenance, e.g. the UDR 1 may be considered unique on the basis of its specific owner (e.g. a celebrity) or on the basis of its specific presentation history (e.g. having been exhibited in a famous gallery or museum).

During the uniqueness verification process, the UDRP 10 may compare the UDR 1 with all or a selection of one or more UDRs within the UDRE 1000. The comparison may be based on a similarity analysis, e.g. by comparing the vulnerable data and/or metadata of the respective UDRs, and may require, for instance, in case when high similarity is detected, an additional human decision. The comparison may operate directly on the raw data of the respective UDR and/or on a representation of the raw data (e.g. a fingerprint, hash).

The UDR 1 can take on different forms. For instance, the UDR 1 is referred to as an encrypted UDR 1 if at least some of its data is encrypted. In other words, at least some of its data requires additional data, such as a key, to be readily readable by a suitable device. In general, an encrypted UDR refers to a UDR whose vulnerable data, e.g. the raw data used for its creation, is not readily derivable from the UDR. However, its vulnerable data is reconstructable by a decryption procedure.

On the other hand, the UDR 1 is referred to as unencrypted in case its vulnerable data is derivable from the unencrypted UDR 1 solely based on the data contained in the unencrypted UDR 1. Or, more generally, an unencrypted UDR refers to a UDR comprising vulnerable data that is (temporally) unencrypted.

Finally, the UDR 1 is referred to as a sealed UDR in case the UDR 1 comprises data with embedded seal data.

In at least one embodiment, the UDRP 10 is arranged to process the UDR 1 on the basis of condition data. The condition data may specify which process is to be carried out by the UDRP 10 or provide additional information required by the UDRP 10 to perform an action.

The processing of the UDR 1 by the UDRP 10 may be based on and/or triggered by one or more processing requests. The processing request may be received from a user and/or another computer system. However, the UDRP 10 may also process the UDR 1 without an explicit request received from a user, but act on the basis of preprogrammed and/or automatically initiated triggers.

In general, requests addressed to and processes executed by the UDRP 10 can be of various nature and coming from various types of users of the UDRE 1000.

For instance, the following user roles of the UDRE 1000 can be identified:

Uploader 50, e.g. an artist who originally created the raw data 21: A person who uploads the raw data 21 to the UDRP 10 for the creation of the UDR 1. In general, the uploader 50 is known within the UDRE 1000, i.e. the uploader 50 may have a user account with the UDRE 1000.

Owner 51: A person who owns the rights for the UDR 1. The owner 51 is known within the UDRE 1000.

External Person 52: An external person 52 might be known or unknown within the UDRE 1000. Thus, an external person 52 does, in general, not require a user account at the UDRE 1000.

Potential Buyer 53: A potential buyer 53 is someone who is interested in buying a UDR 1.

Users can also operate under several roles at the same time. For instance, the uploader 50 may initially be also the owner 51 of the UDR 1—until the uploader 50 transfers the ownership of the UDR 1.

In the following some examples of requests addressed to the UDRP 10 are given.

For instance, the creation request 2 comprising raw data 21 whereupon the UDR 1 is created may be sent by the uploader 50. The owner 51 of the UDR 1 may send a request for presentation of the UDR 1. For instance, the owner 51 of the UDR 1 may send a request to present the UDR 1 in a gallery or at the owner's home.

An external person 52, for instance, a visitor in a gallery, may send a validation request 3 to validate the legitimacy of a displayed or presented UDR 1. For instance, the external person 52 may see a presentation of the UDR 1 in a gallery, record the presentation and send the validation request 3 to the UDRP 10 for validating the legitimacy of the presentation in the gallery based on the recording.

A potential buyer 53 or the owner 51 of the UDR 1 may send a request for transfer of ownership. For instance, a potential buyer 53 may contact the owner 51 of the UDR 1 via the UDRE 1000 and upon approval by the owner 51 a process for transferring the ownership of the UDR 1 is initiated in the UDRP 10.

Additionally or alternatively, the external person 52 and/or the owner 51 of the UDR 1 may send a request to display a transaction history, i.e. the provenance, of the UDR 1.

The processing request received by the UDRP 10 may comprise condition data, e.g. instructions that prompt the UDRP 10 to perform one or more actions. The action to be performed by the UDRP 10 may be related directly or indirectly to one or more UDRs. The condition data may allow the UDRP 10 to identify the one or more UDRs related to the action to be performed.

The condition data may be transferred to the UDRP 10 all at once or in several steps. In particular, processing a request may require an interaction between the UDRP 10 and the sender of the request. During the interaction the condition data may be acquired by the UDRP 10.

The action may require the UDRP 10 to operate with the unencrypted UDR 1 or it may require the UDRP 10 to operate with encrypted data of the UDR 1. Alternatively, an action may be only indirectly related to the UDR 1 and in particular not require the UDRP 10 to operate directly with the UDR 1, neither in unencrypted nor encrypted form.

In case processing requires the UDRP 10 to process parts of the UDR 1 in unencrypted form, the UDRP 10 automatically limits access to the parts of the UDR 1 that were unencrypted, e.g. after finishing a process. The automatic limitation of access to the unencrypted UDR 1 is a security feature of the UDRP 10.

The automatic limitation of access to the unencrypted UDR 1 can be triggered by various factors, for instance, the limitation of access can take place as a last step in the process of executing the action prompted by the processing request, or the limitation of access to the unencrypted UDR 1 can take place after a predetermined time interval, where the time-interval after which access to the unencrypted UDR 1 should be limited may be indicated in the request.

In case the UDRP 10 is not able to complete the action, for instance, within a particular time limit, access to the unencrypted UDR 1 may be limited anyway. For instance, the UDRP 10 may have a timer that keeps track of the time during which the unencrypted UDR 1 is present in the UDRP 10. If the time interval determined by the timer passes a predetermined threshold, access to the unencrypted UDR 1 is limited, irrespective of whether the action was completed successfully or not.

The processing request may be sent by a user via an application, for instance, a management application and/or a validation application, which is part of the UDRE 1000. In order to send the processing request, the user may need to have an account, in particular an account that requires log-in details, at the UDRE 1000. An account may especially be needed, whenever the processing of the processing request requires handling of the unencrypted UDR 1 or the raw data 21 associated with the UDR 1.

However, if the processing request does not require the handling of the raw data 21 of the UDR 1, it may not require the user to have an account with the UDRE 1000, for instance, the processing of the validation request 3 for validating the legitimacy of a presentation of the UDR 1 may not require the user to have an account, i.e. the request to validate the legitimacy of a presentation of the UDR 1 can be sent to the UDRP 10 e.g. by the external person 52.

In one embodiment, processing of the UDR 1 comprises encrypting the unencrypted UDR. For the sake of brevity, only the case where encryption of the UDR 1 is based on a symmetric encryption algorithm using an encryption key is described in detail. However, in general, the encryption of the UDR 1 may be based on other encryption algorithms.

In particular, the encryption of the UDR 1 may be based on asymmetric encryption algorithms. In that case, an encryption key for encrypting the UDR 1 and a decryption key for decrypting the UDR 1 are associated with the UDR 1. In general, in case of asymmetric encryption, the encryption key and the decryption key are different.

The process of encryption may be automatically initiated, for instance, shortly after the creation of the UDR 1. The UDRP 10 may reply to the receipt of the creation request 2 by asking to provide data to be used by the UDRP 10 for the encryption. Alternatively, the encryption key of the UDR 1 may also be generated by the UDRP 10 without additional data provided to the UDRP 10.

The UDRP 10 may generate the encryption key associated with the UDR 1 and encrypt the UDR 1 or a subset of the UDR 1 to form an encrypted UDR 1. The generation of the encryption key may be based on the condition data.

In one embodiment, the generation of the encryption key is based at least on an internal key which is generated by and saved in the UDRP 10.

In addition or alternatively, the generation of the encryption key may be based on an external key, which is provided to the UDRP 10. The external key may be provided to the UDRP 10 by a user, in particular by the owner 51 of the UDR 1.

The internal key is kept in the UDRP 10 and not shared with users of the UDRP 10. In particular, it is not shared with the owner 51 of the UDR 1. The inclusion of the internal key in the generation of the encryption key therefore has the consequence that once the UDR 1 is uploaded in the UDRE 1000, the owner 51 can only access the unencrypted UDR 1, or the raw data 21 associated with the UDR 1, via the UDRP 10 (given that the owner 51 did not keep an accessible copy of the raw data 21).

On the other hand, the external key, on which the encryption key may be additionally or alternatively based on, is in general, only temporally present in the UDRP 10. In particular, the external key may only be present in the UDRP 10 as long as it is needed by the UDRP 10 to execute a task. For instance, the UDRP 10 may use the external key to generate the encryption key and after that the UDRP 1 may automatically erase the external key or automatically limit the access to the external key. In addition or alternatively, the UDRP 10 may delete the external key within a certain timeframe, e.g. the UDRP may be programmed to delete the external key within a few seconds or milliseconds after receiving it.

The inclusion of the external key in the encryption key of the UDR 1 has the consequence that the UDR 1 is not accessible by the UDRP 10 without the external key provided by the user. Thus, the inclusion of an external key has the consequence that the UDRP 10 may not access the unencrypted UDR 1 without explicit permission by the user since the recreation of the encryption key requires the user to resubmit the external key to the UDRP 10.

The usage of the internal or the external key or a combination thereof as the basis for the encryption key of the UDR 1 provides different security features. In some embodiments, the UDRP 10 may be configured to always require an internal and/or external key for each UDR. In other embodiments the usage of internal and/or external key may depend on the UDR 1. For instance, the choice of which combination of internal and/or external key is used for the encryption key of the UDR 1 may depend on the content or the value of the UDR 1. In some embodiments the choice of which combination to choose, may lie with the UDRP 10. In other embodiments the choice of which combination to choose, may lie with a user, in particular, the owner 51 of the UDR 1.

Analogously, in case the processing involves decrypting an encrypted UDR1, the UDRP 1 (re)generates the encryption key associated with the UDR 1. The condition data may contain information allowing the UDRP 10 to identify the encryption key to be used for the decryption of the UDR 1.

In case the encryption of the UDR 1 is based on asymmetric encryption, the decryption key for decrypting the UDR 1 may be based on an internal and/or external key for decryption. The internal key for decryption in general differs from the internal key for encryption. Similarly, the external key for decryption in general differs from the external key for encryption.

In addition or in another embodiment, processing of the UDR 1 involves transmitting the encrypted UDR 1 to a specific storage location. The storage location may be identifiable based on the condition data.

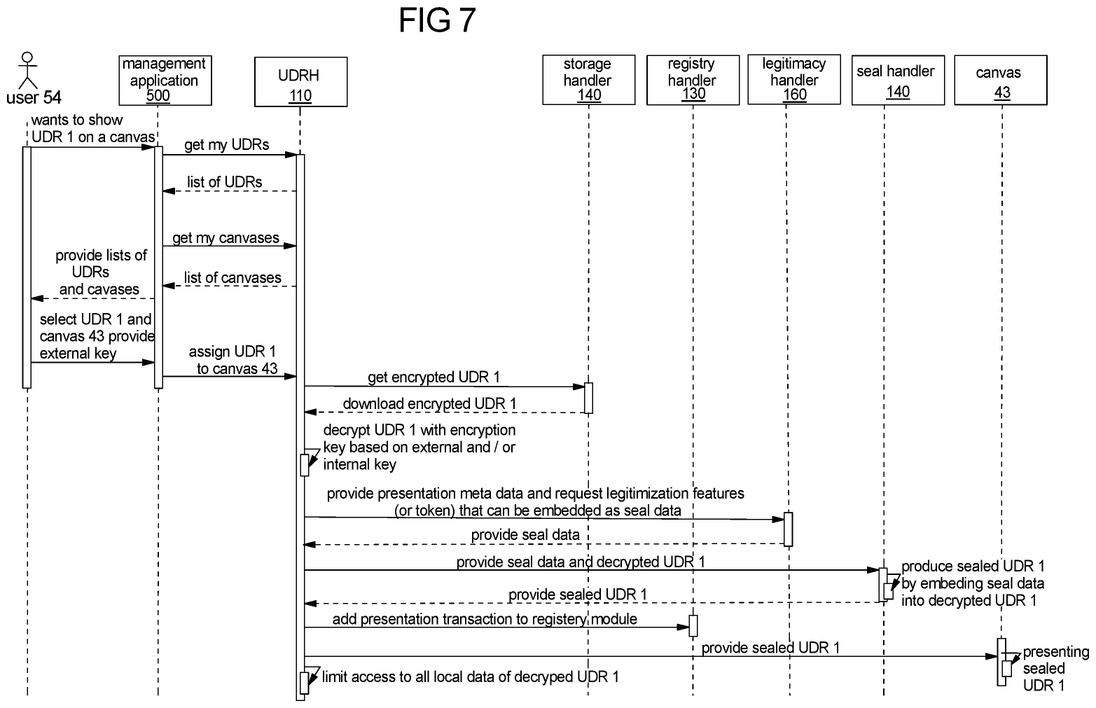

In addition or in another embodiment, processing of the UDR 1 involves generating seal data, also called seal, for a presentation of the UDR 1 and embed the seal data into the UDR 1 to generate a sealed UDR. The condition data may comprise information to be included in the seal data. In particular, the seal data may encode the condition data. The sealed UDR may then be transmitted to a display device and then displayed e.g. on a digital display in a gallery. Further details of presenting the UDR 1 are exemplarily described with reference to FIG. 7.

In another embodiment, the UDRP 10 receives the validation request 3 for validating the legitimacy of a presentation of the UDR 1. The validation request 3 is based on representation data of the presented UDR 1. The representation data may be created based on an image, a video or a (sound) recording of the presentation of the UDR 1. In particular, the representation data of the presentation of the UDR 1 may differ from the (sealed) UDR 1. The representation data may be easily producible, in particular, producing the representation data may only require equipment that is easily available, for instance, the representation data may comprise a recording made by a phone or an ordinary camera.

For processing the validation request 3, extracted seal data of the presented UDR 1 needs to be made available to the UDRP 10. The extracted seal data may be included in the validation request 3 itself or, in another embodiment, the UDRP 10 may be arranged to extract seal data from the representation data of the UDR 1. In that case, the representation data may be submitted to the UDRP 10 together with the validation request 3.

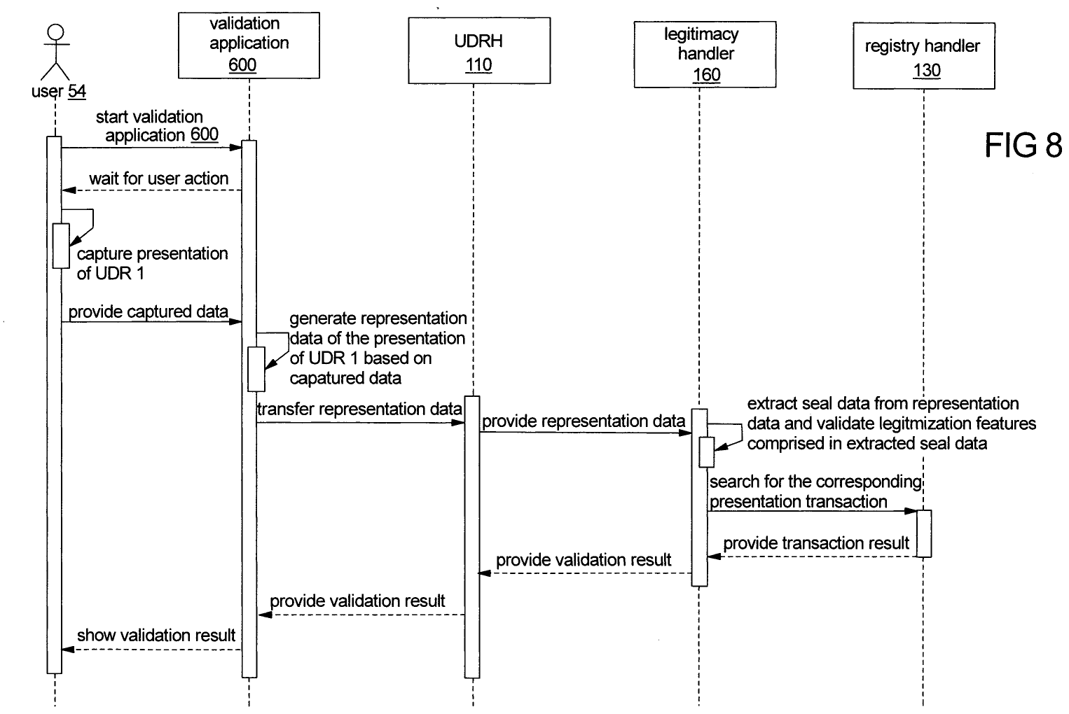

Based on the extracted seal data, the UDRP 10 may determine whether the presentation of the UDR 1 is legitimate. Further details of the procedure of validating the legitimacy of a presentation of the UDR 1 are explained with reference to FIG. 8.

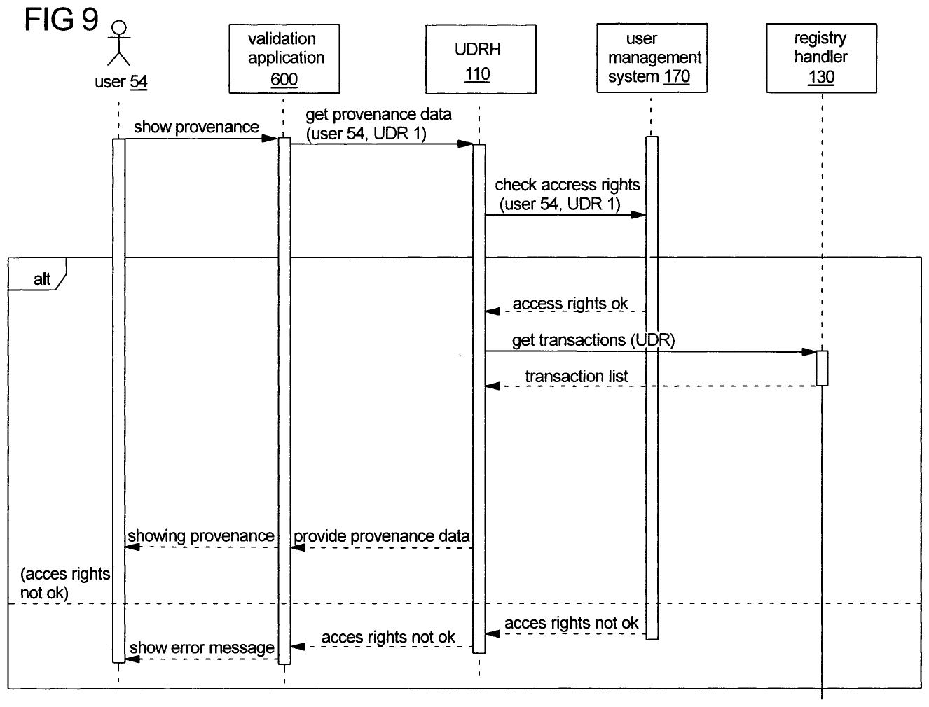

In addition or in another embodiment, processing of the UDR 1 involves displaying the provenance of the UDR 1, which is further described with reference to FIG. 9.

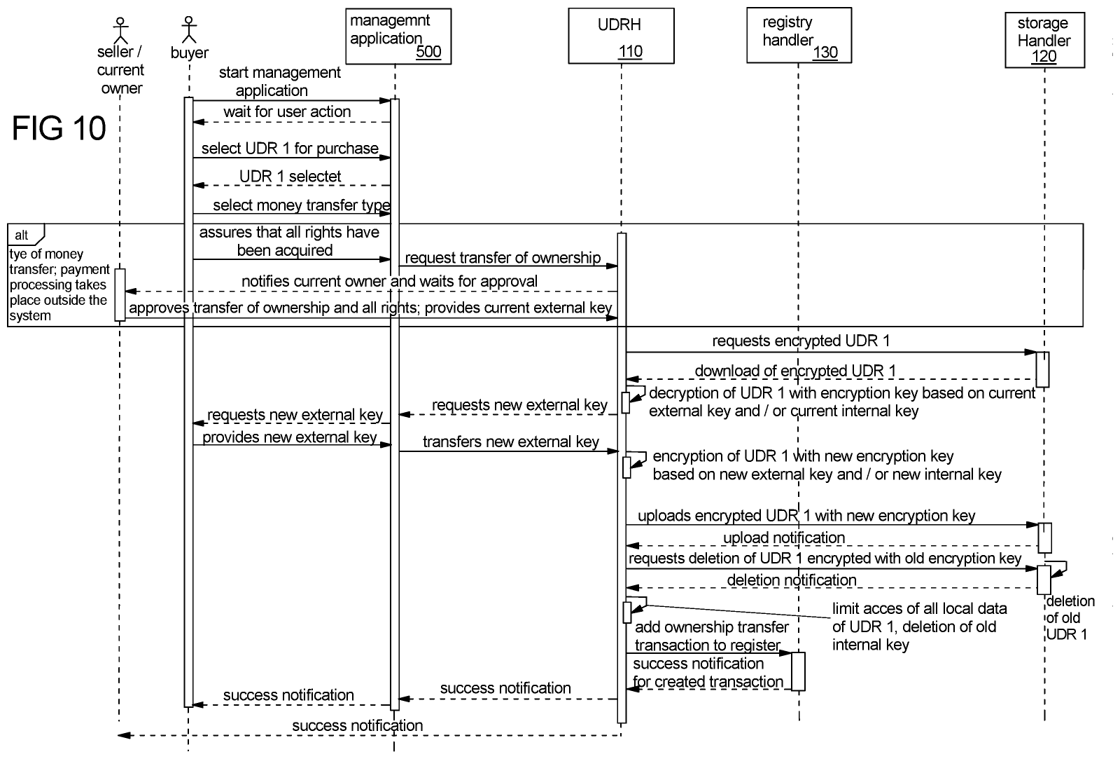

In addition or in another embodiment, the processing involves a transfer of ownership which is further described with reference to FIG. 10.

Moreover, more use cases for the UDRP 10 exist that are not presented here for the sake of brevity. These include for example: the management of usage rights of UDR 1 as well as the offering, sharing, renting and recycling of the UDR 1 or the management of user accounts.

With the introduction of a marketplace system (that can be operated by third parties), further essential use cases for the UDRP 10 evolve. For example, the UDRP 10 needs to enable searching and listing of UDRs 1 and should also offer cases like the management of usage rights, offering, sharing, renting and recycling of the UDR 1 for both end-users and third-party systems (like marketplace systems) via appropriate interfaces.

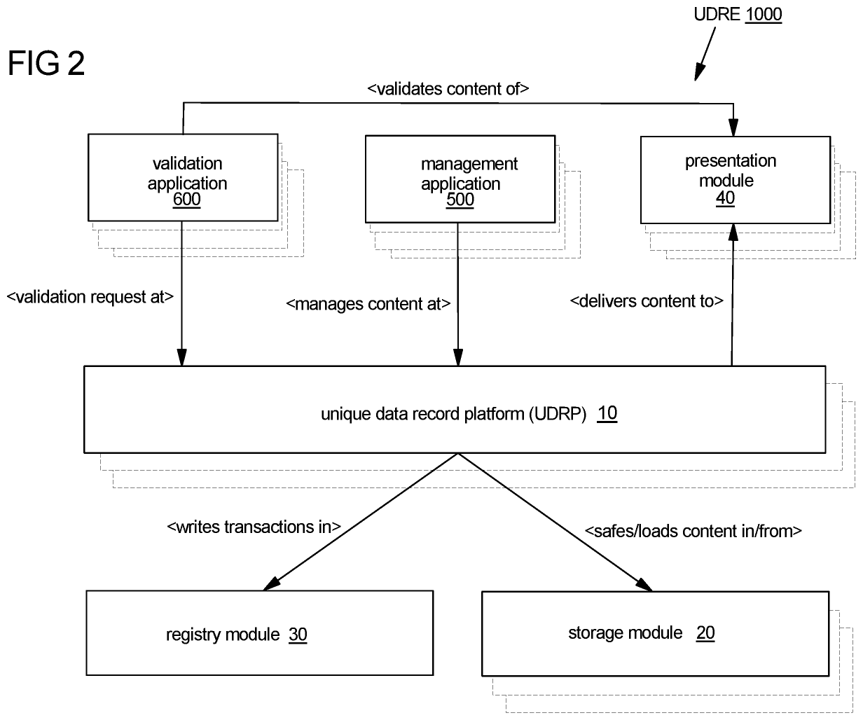

FIG. 2 shows exemplary components that may be part of or be associated with the UDRE 1000. The UDRE 1000 may comprise one or more instances of each component. In fact, all components apart from the UDRP 10 are optional and may not be part of the UDRE 1000. For simplicity and not limiting this general characteristic of the UDRE 1000, this description refers to a single instance of each component. Each component may comprise hardware and/or software.

The UDRE 1000 comprises at least the UDRP 10. The UDRP 10 is coupleable with at least one storage module 20 and with a registry module 30. Furthermore, the UDRP 10 is coupleable to at least one presentation module 40.

In addition, the UDRP 10 may be coupleable to at least one management application 500 and at least one validation application 600.

Briefly, the UDRP 10 saves content, in particular encrypted UDRs, in and loads content from the storage module 20. The storage module 20 stores the content, in particular the encrypted UDRs.

Furthermore, the UDRP 10 writes transaction data in the registry module 30, for instance, the UDRP 10 may automatically generate after each process a transaction report and sends that to the registry module 30. The registry module 30 then stores the transaction data, in particular the transaction reports. Moreover, the UDRP 10 delivers content, in particular sealed UDRs, to the presentation module 40. The presentation module 40 presents the sealed UDRs. The validation application 600 validates content, in particular a presentation of the sealed UDR, of the presentation module 40. In particular, the validation application 600 may request the UDRP 10 to validate the legitimacy of the presentation of an UDR. Finally, the management application 500 manages content related to the UDRs at the UDRP 10. In particular, the management application 500 allows users to communicate with the UDRP 10.

The storage module 20 may comprise a plurality of storage units intended to safely store the encrypted UDR 1. The storage module 20 may be fully or partially contained in the UDRE 1000. In particular, the storage module 20 may comprise parts that are only partially controllable by the UDRE 1000, in particular by the UDRP 10. For instance, the UDRP 10 may not be able to unconditionally access all data stored in a storage unit of the storage module 20.

Parts of the storage module 20, in particular one or more storage units of the storage module 20, may only be controllable by one or more particular users of the UDRE 1000. However, these storage units may still be supported by the UDRP 10, in particular the UDRP 10 may send data to these storage units and/or receive data from these storage units based on specific user request.

In general, the storage module 20 only stores and has access to the encrypted UDR 1. In particular, the storage module 20 has no access to the original or raw data 21 or the vulnerable data of the UDR 1. In fact, the UDRP 10 may be arranged to never send the unencrypted UDR 1 to the storage module 20.

The storage module 20 may comprise local and/or distributed storage. In particular, a unit of the storage module 20 may comprise local and/or distributed storage.

In general, the storage module 20 may comprise untrusted and/or unsecured entities such as public storage or a local file system. In particular, the storage module 20 may comprise, so-called cloud storage. In addition or alternatively, the storage module 20 may comprise portable storage, such as a USB flash drive or an SD-card.

The storage module 20 may comprise storage units that are trusted by the UDRP 10 and/or the storage module 20 may comprise units that are not trusted by the UDRP 10. On the other hand, one or more storage units of the storage module 20 may be trusted by a user, for instance, a storage unit of the storage module 20 may be trusted by the owner 51 of the UDR 1. For instance, the owner 51 of the of the UDR 1 may trust a storage unit and allow the UDRP 10 to store the encrypted UDR 1 in that storage unit.

The storage module 20 may fully or partially be provided by a third party external to the UDRE 1000. The UDRE 1000 and in particular the UDRP 10 does not support or provide storing unencrypted raw data of the UDR 1 on untrusted or unsecured storage modules 20 or untrusted or unsecured storage units of the storage modules 20.

Generally, untrusted or unsecured storage units of the storage module 20 should strictly be denied access to critical data (e.g. vulnerable data, sensitive data); in particular, such storage units should generally be denied storing unencrypted vulnerable or raw data 21 of the UDR 1.

The UDRP 10 is arranged to retrieve the encrypted UDR 1 from the storage module 20, in particular on the basis of a request. The retrieved UDR 1 may then be decrypted by the UDRP 10 via the encryption key associated with the UDR 1.

On the other hand, the UDRP 10 may transmit the encrypted UDR 1 to the storage module 20. In particular, the UDRP 10 may determine, for instance, based on a request, that the encrypted UDR 1 is to be stored in a particular storage unit of the storage module 20. The particular storage unit of the storage module 20 where the UDR 1 is to be stored may be determined by a user of the UDRP 10, in particular by the owner 51 of the UDR 1. For instance, the user may request the UDRP 10 to store the encrypted UDR 1 in a storage unit, comprising personal local storage, such as a USB flash drive, personal computer or smartphone. The owner 51 of the UDR 1 may inform the UDRP 10 on where the encrypted UDR 1 is to be stored.

The storage module 20 may be fully or partially included in a data system like a USB or Cloud Storage and may be provisioned by various stakeholders (such as galleries, collectors, single persons, etc.). The UDR 1 stored in the storage module 20 is always encrypted so that the storage provider, specifically the provider providing the storage unit where the UDR 1 is saved, is not able to usefully process the data of the UDR 1.

The storage provider never knows the encryption key or parts of it. The storage module 20 may be fully or partially linked to or owned by the owner 51 of the UDR 1.

The storage module 20 may contain an exclusive copy of the UDR 1.

The registry module 30 is arranged to keep track of transactions related to the UDR 1 and/or to provide transaction data (transaction history) of the UDR 1 in a tamper-proof way, e.g. by using a blockchain. The registry module 30 stores metadata related to the UDR 1. In general, the registry module 30 is denied access to the UDR 1, even in encrypted or sealed form.

The processing of a request and/or the execution of a specific action by the UDRP 10 may prompt the UDRP 10 to automatically generate transaction data. Alternatively, the transaction data may be generated based on the type of action that was performed and/or the request may specifically require the generation of transaction data and/or deny the generation of transaction data.

The UDRP 10 may (automatically) transmit the transaction data to the registry module 30. For instance, transmission of the encrypted UDR 1 to the storage module 20 may prompt the UDRP 10 to automatically generate transaction data comprising e.g. the information that the UDR 1 has been transmitted to a specific storage unit of the storage module 20 which is then automatically transmitted to the registry module 30. The transaction data may thus comprise a unique identifier of the UDR 1 (e.g. a random sequence of numbers) and an address of the specific storage unit of the storage module 20 where the UDR 1 is transmitted to. Furthermore, the transaction data may comprise the specific date and time of the transaction.

The registry module 30 keeps track of transactions associated with the UDR 1 and may be implemented as a subsystem of the UDRE 1000.

In one embodiment, the registry module 30 stores usage transactions (e.g., in the form of a log file or log database), in particular the registry module 30 stores transactions related to the UDR 1. The registry module 30 stores transactions in a tamper-proof way and/or provides transaction data, in particular a transaction history (provenance), in a tamper-proof way.

The registry module 30 may comprise a distributed ledger technology, for instance, a blockchain technology. With that, transactions become referenced and are made available for the processing throughout the UDRP 10.

In at least one embodiment, the UDRP 10 is arranged to communicate metadata to the registry module 30; in particular, the UDRP 10 is arranged to communicate metadata to the registry module 30 based on a request. The metadata of a transaction may comprise a unique identifier of the UDR 1 and/or metadata associated with the UDR 1.

A transaction stored in the registry module 30 may comprise legitimization features associated with a presentation of the UDR 1, for instance, the legitimacy period of the presentation, an indication of one or more specific conditions the presentation must satisfy (e.g., at a particular geo-location and/or a specific time period). The registry module 30 may also store metadata related to a uniqueness verification level of the UDR 1.

The transaction data stored in or referenced by the registry module 30 may, e.g., comprise the transaction unique identifier (e.g., a URI of the transaction) of the UDR 1, the type of the transaction, an indicator data set (doctype version) related to the version of the transactional data of the coding (transactions of the same type might exist in different versions, because of different versions of system implementations; the doctype version ensures that the data structure of the transaction refers to a specific version of a system implementation) and/or other metadata related to the transaction.

The information content, in particular the metadata, of transactions stored or referenced in the registry module 30 may be comparable for all transactions of the same type.

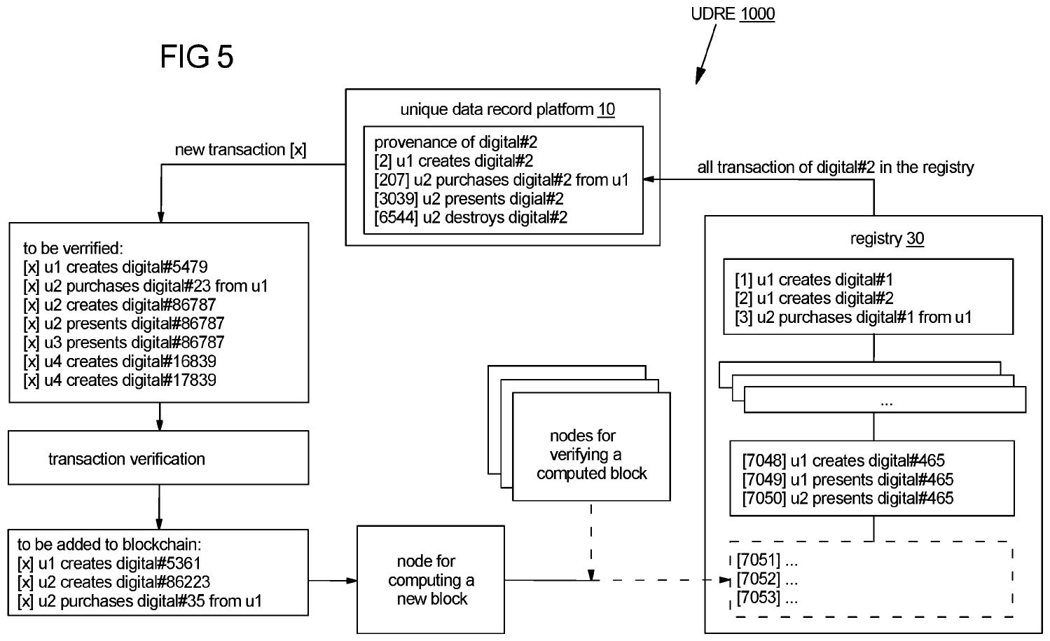

A specific embodiment of the registry module 30 is described with reference to FIG. 5.

The presentation module 40 is arranged to present the sealed UDR, e.g. on a display in a gallery. The presentation module 40 may comprise one or more presentation units (also called canvases).

The presentation module 40 may be fully or partially contained in the UDRE 1000 (see e.g. FIG. 1). In particular, the presentation module 40 may comprise one or more presentation units that are controllable by the UDRP 10. On the other hand, one or more presentation units of the presentation module 40 may not be controllable by the UDRP 10. A presentation unit that is not controllable by the UDRP 10 may be controllable by a user of the UDRE 1000.

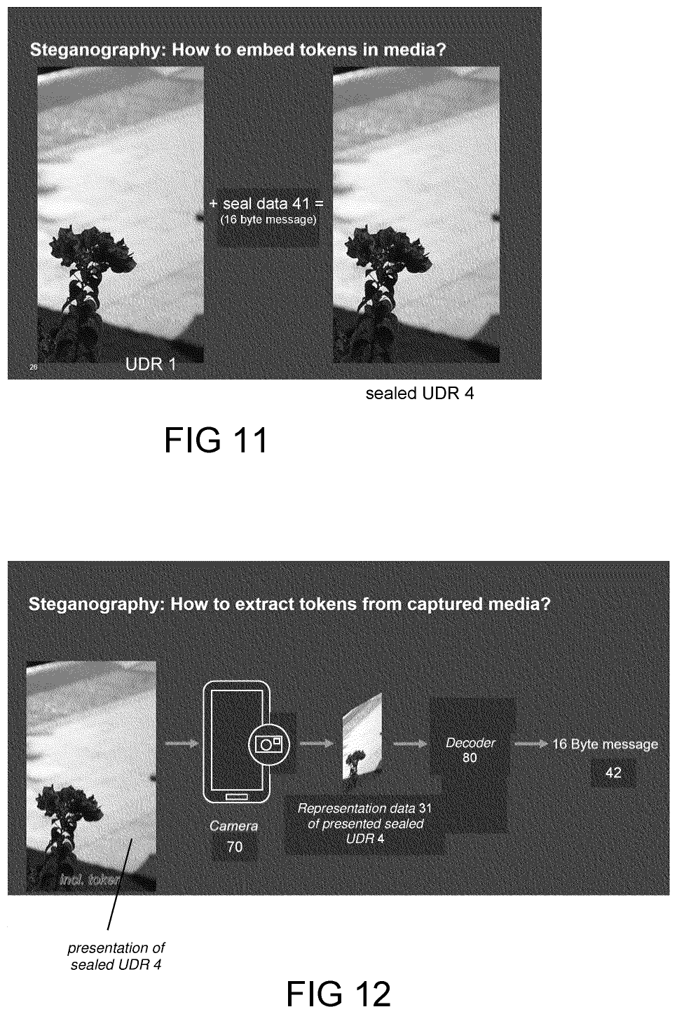

The presentation module 40 presents or displays a sealed UDR (see e.g. FIG. 11). The presentation module 40 may comprise hardware and/or software that enables the presentation of the sealed UDR.

A presentation unit of the presentation module 40 may be associated with a unique identifier. In particular, each presentation unit of the presentation module 40 may comprise a (different) unique identifier that enables the UDRP 10 and/or the management application 500 to identify the presentation unit.

The presentation module 40, and/or a specific unit of the presentation module 40 may comprise a mobile device, e.g. a smartphone, a computer, a digital screen or display e.g. in a gallery, an electronically operated audio sound system, a projector, or any other electronic device with the ability to present the sealed UDR. The presentation module 40 can control the output (display, audio etc.) of at least one of the mentioned devices.

The presentation module 40 and/or a particular presentation unit of the presentation module 40, may be coupleable to the UDRP 10 and/or to the management application 500.

The presentation module 40, in particular a presentation unit of the presentation module 40, may be associated with a user account. The association to the user account can be established manually, for instance, by logging in to the user account via the presentation module 40. Alternatively, the association to the user account may be established via the management application 500; in particular, the management application 500 may discover the association to the user account (e.g., by using local and/or network discovery mechanisms, such as Bluetooth or the Discovery and Launch Protocol DIAL).

The presentation module 40 and/or the unit of the presentation module 40 that presents the UDR 1 may be selectable by a user. In particular, the unit of the presentation module 40 that presents the UDR 1 may be selected via the management application 500.

An exemplary process of the presentation of the sealed UDR is described with reference to FIG. 7.

The application components of the UDRE 1000, in particular the management application 500 and/or the validation application 600 allow users to communicate with the UDRP 10.

The management application 500 may allow a user to communicate with the UDRP 10. In particular, the management application 500 may allow the user to address a processing request to the UDRP 10.

The management application 500 may be installed on an electronic device of the user, for instance, on the user's phone, tablet or computer.

The management application 500 allows a user to manage the UDR 1. For instance, the management application 500 may enable the user to request the upload of raw data 21 to the UDRE 1000; in particular, the management application 500 may allow the uploader 50 to upload raw data 21 to the UDRP 10 and to request the UDRP 10 to create the UDR 1 and integrate the UDR 1 into the UDRE 1000.

The management application 500 may also provide metadata associated with the UDR 1 to the UDRP 10. For instance, the management application 500 may delegate an external key provided by a user, in particular by the owner 51 of the UDR 1, to the UDRP 10.

The management application 500 may also enable a user to send a request for transfer of ownership of the UDR 1 to the UDRP 10.

Furthermore, the management application 500 may request the presentation of the UDR 1 in the presentation module 40, in particular in one or more specific units of the presentation module 40.

In general, the management applications 500 sends a request for presentation based on user input. However, the request for presentation may also be sent by the management application 500 based on specific settings or based on automatic triggers.

The management application 500 may be coupleable to the presentation module 40, in particular the management application 500 may be coupleable to one or more units of the presentation module 40.

The management application 500 may allow a user to choose the UDR 1 and one or more units of the presentation module 40, where the UDR 1 is to be presented.

The validation application 600 allows a user to communicate with the UDRP 10. The validation application 600 allows, for instance, to send the validation request 3 to validate the legitimacy of a presentation of the UDR 1 to the UDRP 10. In particular, the validation application 600 may allow to send a request to validate the legitimacy of a presentation of the UDR 1 displayed by the presentation module 40 or displayed by a particular unit of the presentation module.

The validation application 600 may be used and/or operated by the external person 52. The external person 52 may, e.g., be a fan or a visitor of a gallery.

In one embodiment, the validation application 600 is installed on an electronic device, such as a smartphone that is able to produce representation data, in particular a recording, of the presentation of the UDR 1. The recording may comprise an optical digital recording of at least a part of the presentation of the UDR 1, e.g. comprising a picture (photograph) or a video, and/or sound recording of the presentation of the UDR 1. In addition or alternatively, the recording of the presentation of the UDR 1 may be based on Bluetooth signals broadcasted by and/or derived from the presentation of the UDR 1. The validation application 600 is arranged to process the recording of the presentation of the UDR 1.

In general, in order to create representation data of the presentation UDR 1, physical access to the presentation module 40 and/or to the data based on which the presentation module 40 creates the presentation of the UDR 1, such as the actual displayed media file, is not required.

In at least one embodiment, the validation of the legitimacy of a presentation of the UDR 1 is based on optical access to the presentation of the UDR 1 by the validation application 600. In particular, the optical access may be provided by a camera associated with the electronic device, such as a smartphone camera.

The UDRP 10 validates the legitimacy of the presentation of the UDR 1 on the basis of the validation request 3. The validation request 3 is based on the representation data and the UDRP 10 validates the legitimacy of the presentation of the UDR 1 based on extracted seal data extracted from the representation data. In addition or alternatively, the validation of the legitimacy of the presentation of the UDR 1 may be carried out by the validation application 600.

In at least one embodiment, the validation application 600 may transmit the validation request 3 to the UDRP 10 by sending the representation data to the UDRP 10. Alternatively, the validation application 600 may extract seal data from the representation data and transmit the extracted seal data to the UDRP 10.

The extracted seal data is associated with legitimization features relating to the presentation of the UDR 1. In particular, the extracted seal data may contain the legitimization features or a reference (token) to the legitimization features.

The result of the validation procedure carried out by the UDRP 10 (or by the validation application) on the basis of the validation request 3 may be presented via the validation application 600; in particular, the validation application 600 may present the result determined by the UDRP 10 to the external person 52. An embodiment of the validation process is described with reference to FIG. 8.

In summary, the whole UDRE 1000 shall enable the safe storage, the legitimized presentation as well as the validation of the legitimacy of presentations and the verification of the uniqueness of digital media (UDRs). All transactions related to the UDRs should be stored in the registry module 30.

The UDRE 1000 may be a decentralized infrastructure that is why four different kinds of trust exist. Each component is allocated to one of the following trust categories:

Trusted components need to process raw data 21 associated with UDRs or unencrypted UDRs as part of the UDRP 10. The raw data 21 (or vulnerable/sensitive data) of the UDRs is the asset in the UDRE 1000 requiring the highest level of protection against attackers; therefore, these components must be absolutely trustworthy. If trusted components get attacked successfully, the security and trustworthiness of the whole infrastructure is compromised. For example, UDRs are not tamper-proof anymore and provenance data loses its trustworthiness.

Certified components (e.g., the management application 500 and/or the validation application 600) are not part of the UDRP 10, but sometimes process critical data (e.g., data that might be related to UDR security, to UDR presentation legitimacy or to user authentication). For example, apps for uploading a new UDR, for requesting an external key or for validating the legitimacy of presentations of UDRs. The end user thus has to be able to trust these components. Components should be certified by a trustworthy entity. If these components get attacked, their subsequent actions (related to the digital media or validation result) might be compromised and no longer trustworthy, whereas the remainder of the infrastructure stays intact and safe.

Third-party components (e.g., the storage module 20, the presentation module 40, and/or a marketplace system) are generally not part of the UDRP 10 and do not process critical data. Independent third-party providers can provide those components. In this way, a smartphone, for example, can also serve as a presentation unit of the presentation module 40 or the encrypted UDR can be stored on an arbitrary cloud-storage. If these components become compromised, the respective UDR 1 might be affected, e.g., in terms of availability and/or in terms of presentability.

The registry module 30 is a tamper-proof component of the UDRE 1000. The registry module 30 may be implemented as a subsystem that allows storing transactions in a temper-proof way. The users' trust in the registry module 30 is essential for the overall acceptance of the UDRE 1000. The trust might base on the unassailability of the technology, the warranties of the registry module's operator(s) and/or the principal of consensus—e.g., only if a majority of the institutions involved rates the respective transaction as valid it will be permanently accepted as valid. If the registry module 30 becomes compromised, the encrypted UDRs are still protected but the persisted transactions (provenances) are no longer trustworthy.

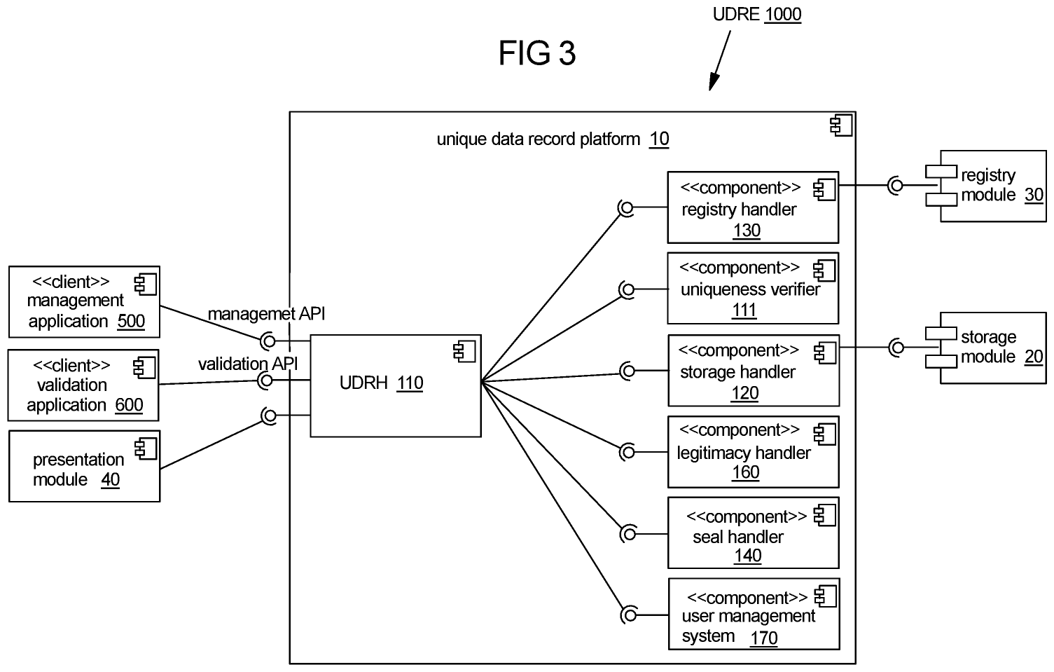

FIG. 3 describes an exemplary embodiment of the UDRP 10 comprising a plurality of components.

The UDRP 10 may comprise a unique data record handler (UDRH) 110 as the central component for managing all tasks of the UDRP 10.

In addition, the UDRP 10 may comprise components to offer micro-services that are specialized on certain tasks (e.g., the generation of seal data). These components may at least comprise a uniqueness verifier 111, a storage handler 120, a registry handler 130, a seal handler 140, and/or a legitimacy handler 160. In general, the UDRP 10 may comprise none, one or more instances of each component type, e.g., it may comprise none, one or a plurality of uniqueness verifiers, storage handlers, etc.

The UDRH 110 may communicate with other components of the UDRE 1000 via application programming interfaces (APIs). For instance, the UDRH 110 may communicate with the management application 500 via a management API and with the validation application 600 via a validation API. Moreover, the UDRH 110 may communicate with the presentation module 40 via an API.

The UDRH 110 may specify the interfaces and exchange formats (similar to a blueprint) for the specific micro-services in order to be as interoperable as possible. These services can publish and subscribe to the UDRH 110 and thus offer their functions via interfaces implementing the given specifications.

In the following exemplary functions of the specific components are described.

In general, the storage handler 120 is responsible for the connection with the storage module 20, in particular for the data exchange between the storage module 20 and the UDRP 10. The storage handler 120 manages the upload of the encrypted UDR 1 to the storage module 20 and the download of the encrypted UDR 1 from the storage module 20.

The registry handler 130 is responsible for the generation and transfer of transactions to and from the registry module 30.

The uniqueness verifier 111 verifies the uniqueness of the UDR 1. For instance, the uniqueness verifier 111 may verify whether the freshly created UDR 1 based on (freshly uploaded) digital media, in particular based on the raw data 21, is unique within a part of the UDRE 1000.

In one embodiment, the uniqueness verifier 111 is arranged to generate a fingerprint (e.g. a hash of all bytes of the content) of the UDR 1 when the UDR 1 is uploaded to the UDRE 1000 and/or created by the UDRP 10. The comparison of the generated fingerprint of the UDR 1 to fingerprints of already existing UDRs allows the verification of uniqueness of the UDR 1 by the uniqueness verifier 111 throughout (a part of) the UDRE 1000. The fingerprint may be based on the raw data 21 of the UDR 1 and/or on metadata associated with the UDR 1. The fingerprint may by adapted based on transactions related to the UDR 1.

The legitimacy handler 160 manages the legitimization features associated with the UDR 1. Specifically, the legitimacy handler 160 manages the legitimization features associated with a presentation of the UDR 1. The legitimacy handler 160 is able to generate seal data to be embedded in the UDR 1 and read-out seal data (that may consist of tokens or legitimization features) from representation data of a presented UDR 1.

The seal handler 140 embeds seal data that is based on the legitimization features (or a token representing those legitimacy features) into the raw data 21, the UDR 1 and/or into a copy of the UDR 1 which turns the UDR (or its copy) into a sealed UDR. The seal handler 140 is also able to extract seal data from representation data of a presentation of the sealed UDR.

Third parties are enabled to verify and/or validate the legitimacy of a presentation of sealed UDRs. Therefore, they need e.g. visual access to the sealed media for capturing and verifying/validating the legitimization features. Digital media without a seal, with a corrupted/unrecoverable seal or with invalid legitimization features (e.g., as compared to the real situation in terms of time or geo-location) do not represent a legitimate presentation.

The user management system 170 manages user data known to the UDRP 10. For instance, the user management system 170 manages and authenticates user data. The user management system 170 may also supervise or establish the association between a user account and the internal key, if in use, which is not known to the user. The internal key can in one embodiment be unique to the UDR 1 and/or unique to the user. But it is also possible that at least a subset of the UDRs in the UDRP 10 use the same internal key.

In general, the encryption of the UDR 1 is based on an encryption key. The encryption key is based on the internal key and/or based on the external key provided by the owner 51 to the UDRP 10. To create the encryption key, the UDRP 10 combines the internal key (also called salt) with the external key if both of these keys used. The internal key is always associated to the owner's user account in the user management system 170, but not known to the owner 51. The combination of external key and internal key results in the encryption key for encrypting the UDR 1. An external key, however, does not need to be provided. In that case, the generation of the encryption key is based on the internal key. In general, the generation of the encryption key does not require an external key.

In one embodiment, the management application 500 may be operated by an identity provider, for instance, in a silo model for the UDRP 10, specifically via the user management system 170 of the UDRP 10, or as a single sign-on (SSO) approach for the whole UDRE 1000. In one embodiment, users, in particular uploaders 50 and owners 51, need to authenticate via a user account at the user management system 170 before sending a processing request to the UDRP 10.

Each UDR 1 is encrypted for the safekeeping. A decrypted UDR 1 must not be accessible outside of the UDRP 10 but only an encrypted or sealed UDR. In one embodiment, the UDR 1 can only be encrypted after authenticating via the user management system 170.

In general, the transfer of all types of data between the components of the UDRE is encrypted (e.g. by utilizing standard encryption mechanisms, such as HTTPS, HTTP2 or other combinations of asymmetric and symmetric encryption methods).

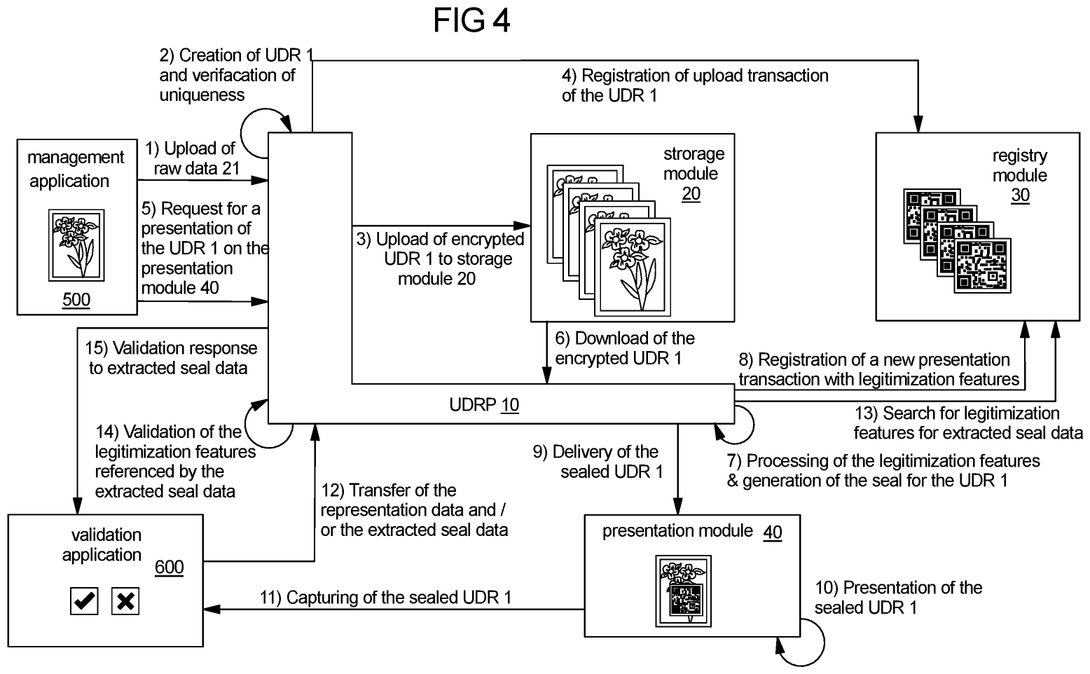

FIG. 4 describes an exemplary process of the claimed solution and is a continuation of the embodiments described with reference to FIGS. 2 and 3.

Steps (1) to (4) describe the creation of the UDR 1 and its integration into the UDRE 1000. Steps (5) to (10) describe the generation of a presentation of the UDR 1 via the presentation module 40, e.g. on a canvas, and steps (11) to (15) describe the process of validating legitimacy of the presentation of the UDR 1.

In a first step (1), digital data, in particular the raw data 21 of the UDR 1 and possibly metadata, is uploaded to the UDRP 10. The digital data may, for instance, be uploaded to the UDRP 10 via the management application 500. The management application 500 may be operated by a user, in particular by the uploader 50 or the owner 51 of the UDR 1. For instance, the management application 500 may be running on the user's smartphone.

After uploading (2), the UDRP 10 creates the UDR 1 based on the raw data 21 and optionally based on the metadata and verifies the uniqueness of the UDR 1. In particular, the uniqueness can be verified by the uniqueness verifier 111 of the UDRP 10. The verification of uniqueness may comprise verifying whether the UDR 1 is truly unique within the UDRE 1000 or parts of the UDRE 1000.

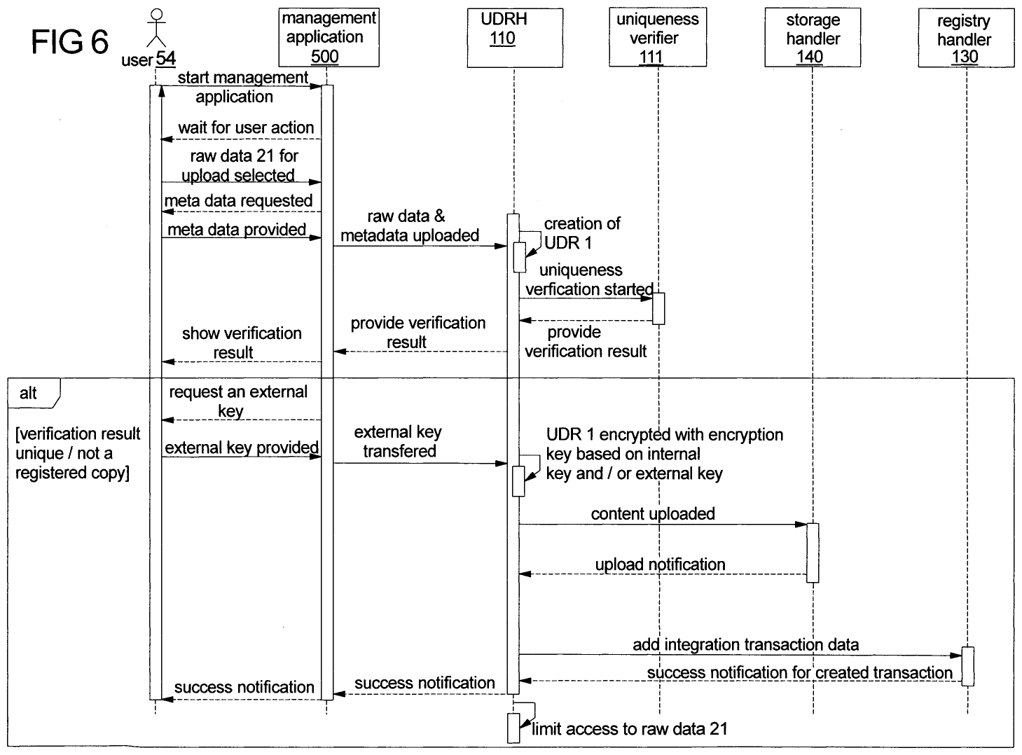

The verification of uniqueness may be implemented by similarity analysis and—e.g., in high similarity cases—with an additional human decision. Further specific embodiments of the uniqueness verifier 111 are elaborated with reference to FIG. 6.

If the verification of uniqueness succeeds, i.e., the UDR 1 is recognized as truly unique (not yet existing) in the UDRE 1000 or a part of the UDRE 1000, the UDR 1 is equipped with a unique identifier.

In addition, the UDR 1 is encrypted with an encryption key. The UDR 1 encrypted with the encryption key is referred to as the encrypted UDR 1. The encryption key is generated based on an internal key, generated by the UDRP 10, and/or on an external key, which may be provided by the user. If in use, only the UDRP 10 generates and stores the internal key for the UDR 1 that is linked to the user's user account but not shared with the user. Thus whenever the encryption requires the internal key, the UDRE 1000 ensures that every encryption of the UDR 1 can only take place in the UDRP 10. In case asymmetric encryption of the UDR 1 is desired, in addition to the encryption key, a decryption key based on an internal and/or an external key may be generated.

Then (3), the encrypted UDR 1 is stored in the storage module 20. The particular storage unit of the storage module 20, where the UDR 1 is stored may, for instance, be determined by the UDRP 10 or chosen by the user.

The UDRP 10 then (4) generates an upload transaction comprising the unique identifier of the UDR 1 and corresponding metadata, and communicates that to the registry module 30. The upload transaction is then saved in the registry module 30.

An authenticated user, for instance the owner 51, can request the presentation of the UDR 1 in the presentation module 40. The request may be submitted via the management application 500 (5). The authenticated user may also request the presentation of the UDR 1 in a specific presentation unit, i.e. a canvas, of the presentation module 40. Whether a user is authenticated is determined via the user management system 170.

When the UDRP 10 receives a request for presentation of the UDR 1, the UDRP 10 downloads (6) the encrypted UDR 1 from the storage module 20. The UDRP 10 then decrypts the encrypted UDR 1 with the decryption key, which in the case of symmetric encryption is the encryption key.

When the encryption key is (partially) based on an external key which was given by the user (e.g., during the upload process or during the ownership transfer process), the user needs to provide the external key to the UDRP 10. If no external key was used in the creation of the encryption key, the authentication of the user is enough to prompt the UDRP 10 to download the encrypted UDR 1 from the storage module 20 and decrypt it with the decryption key.

The UDRP 10 then (7) embeds seal data which references one or more legitimization features of the requested presentation of the UDR 1 into the (decrypted) UDR 1. The UDR 1 which is equipped with seal data is referred to as the sealed UDR.

The one or more legitimization features are stored as part of presentation transaction data in the registry module 30 (8). The one or more legitimization features may indicate that the presentation has a limited legitimacy period or must be presented under specific conditions (e.g., at a particular geo-location).

The sealed UDR 1 is then transferred to the presentation module 40 (9). In particular, the sealed UDR may be transmitted to a canvas of the presentation module 40 indicated by the user.

The canvas then presents the sealed UDR (10).

When a user, e.g. the external person 52, such as a fan or a visitor of a gallery, wants to validate the legitimacy of the presentation of the UDR 1, the user may use the validation application 600. The validation application 600 may be installed on a smartphone of the user. The validation of the presentation of the UDR 1 may require the user to capture the presented sealed UDR 1.

The captured data may be created by taking a picture (photograph) or small video of the presentation of the UDR 1, for instance, via the smartphone.

The captured data is transferred to the validation application 600 (11). The validation application 600 creates representation data 31 based on the captured data.

The representation data 31 represents the presentation of the UDR 1. The representation data may coincide with the captured data transferred to the validation application 600 or the validation application 600 may alter the captured data in order to obtain representation data 31.

The creation of the representation data 31 may in particular neither require physical access to the data used to create the presentation of the UDR 1, in particular actual media files, nor to the presentation module 40.

Instead, the representation data of the presentation of the UDR 1 may for instance, be created on the basis of visual and/or auditory access to the presentation of the UDR 1, for instance, through the smartphone's camera and/or microphone.

The validation application 600 then transfers the representation data 31 to the UDRP 10. The UDRP 10 then extracts seal data from the representation data 31. Alternatively, the validation application 600 may extract seal data from the representation data 31 and transfer the extracted seal data to the UDRP 10 (12).

The UDRP 10 then searches in the registry module 30 for the legitimization features corresponding to the seal data. In particular, the UDRP 10 may search in the registry module 30 for the legitimization features referenced by the seal data (13).

Finally, the UDRP 10 validates (14) the legitimization features and provides (15) a validation response to the validation application 600.

FIG. 5 illustrates a version of the registry module of the UDRE that is realized using a blockchain.

FIG. 5 describes a possible simplified data flow in the registry module 30. When the UDR 1 is processed in the UDRP 10, certain transactions are to be written to the registry module 30. These may include the creation of a UDR 1, verification of the uniqueness of the UDR 1, transfer of ownership, presentation via a presentation module 40, or its deletion. In the UDRP 10, typically all important metadata related to one UDR 1 are processed. New transactions are created based on predefined metadata structures with the corresponding data in the registry handler 130.

Subsequently, a pre-validation of the transactions can be performed. For example, in the case of a presentation via a presentation module 40 or the transfer of ownership, the registry handler 130 might validate in advance whether the ownership rights really belong to the corresponding user. The result is a list of validated transactions to be included in the registry module 30.

In the case of using a blockchain, where the UDR 1 is represented, for example, as a Non-Fungible Token (NFT), the registry module 30 consists of different blocks of transactions. A new block is created by a node (computer system) of a participant participating in the blockchain ecosystem by computing a complex task. A node might be operated by the operator of the UDRP 10 and might be linked to the registry handler 130. Other participants in the blockchain ecosystem must then validate the correctness of the calculation of the task and thus the legitimacy of the new block. For example, according to the Byzantine Agreement Protocol, at least 2/3 of the participants are expected to agree.

The registry module 30, in the case of an implementation based on the blockchain, comprises blocks that build on each other, with the newest block being appended to the end. Thus, a manipulation of one block in the blockchain would make the whole blockchain invalid. The registry module 30 is thus a trusted distributed knowledge base where all blockchain participants can obtain a copy of the current status of transactions.

Depending on the use case, all needed transactions (e.g., all transactions relating to the UDR 1) are loaded for processing in the UDRP 10. Potentially, a representation is forwarded to the validation application 600, for example, as a provenance (history of the UDR 1).

In general, the registry module 30 of the UDRE 1000 allows storing transactions in a tamper-proof way. In one embodiment, the registry module 30 only allows appending new transactions and listing of existing transactions. All operated UDRPs 10 can access all transactions.

All transactions relating to the UDR 1 are registered in the registry module 30. A transaction may comprise data like a transaction unique identifier (e.g., a URI of the transaction), a type of the transaction (e.g., transmission of the UDR 1 to a storage unit of the storage module 20, transfer of ownership of the UDR 1 or transfer of the UDR 1 to a presentation unit of the presentation module 40), a doctype version (transactions of the same type might exist in different versions, because of different versions of system implementations; the doctype version ensures that the data structure of the transaction refers to a specific version of a system implementation), and metadata.

The following exemplary transaction types with the corresponding exemplary data structures can for example be written into the registry module 30. UDR creation transaction data may be generated after a UDR is created; uniqueness verification transaction data may be created after the uniqueness of a UDR has been verified; presentation transaction data may be created after a presentation of a UDR is generated; transfer of ownership transaction data may be created after a process of transferring the ownership of a UDR is completed; and the UDR destruction transaction data may be created after a UDR is destroyed.

UDR creation transaction data may comprise the following data:
transaction identifier (e.g., URI)
transaction type
doctype version
meta—global
   timestamp
   UDR id
   owner id
payload—method specific
   filehash/fingerprint

Uniqueness verification transaction data may comprise the following data:
transaction identifier (e.g., URI)
transaction type
doctype version
meta—global
   timestamp
   UDR id
   owner id
   fingerprint-method
   fingerprint-string
payload—method specific
   uniqueness verification/filehash/fingerprint

Presentation transaction data may comprise the following data:
transaction identifier (e.g., URI)
transaction type
doctype version
meta—global
   timestamp
   UDR id
   owner id
   token-method
   token-string
payload—method specific
   presentation unit id (or canvas id)
   store time how long presentation on canvas is allowed
   store time when presentation on canvas started
   geo location

Transfer of ownership transaction data may comprise the following data:
transaction identifier (e.g., URI)
transaction type
doctype version
meta—global
   timestamp
   UDR id
   old owner id
   new owner id
payload—method specific

UDR destruction transaction data may comprise the following data:
transaction identifier (e.g., URI)
transaction type
doctype version
meta—global
   timestamp
   UDR id
   owner id
payload—method specific

The attributes given on the highest level (e.g. transaction identifier, transaction type and/or doctype version) are present in all transactions. The attribute structure that is shown under “meta” is transaction-type specific. In addition, the attribute structure that is shown under “payload” is transaction-type and method specific (e.g., because the UDRP 10 offers different methods for the verification of uniqueness).

The management application 500 and/or the validation applications 600 could load a local copy of all relevant transactions (for example relating to the UDR 1 via the UDRP 10). For instance, in case a presentation of the UDR 1 is requested by a user, the management application 500 may load a local copy of the data comprising all available canvases of the user from the registry module 30 and e.g. allowing the user to pick a canvas. Similarly, in case the validation application 600 aims to validate a presentation of the UDR 1, the validation application 600 may load a local copy of the legitimization features relating to the presentation from the registry module 30 and validate the legitimacy based on the legitimization features.

In one embodiment, the UDRP 10 is able to request the inclusion of new transactions to the registry module 30 via the registry handler 130. In general, the inclusion of new transaction to the registry module 30 proceeds on an automatic basis.

In one embodiment, when uploading new transaction data to the registry module 30, first, the validity of the transactions is evaluated. This way, transactions that appear invalid are filtered out: For example, if a transfer of ownership is requested to be persisted for a UDR 1 that is not currently owned by one of the two users involved; or if a new UDR 1 is requested to be created which already exists in the registry module 30. If invalid transactions have been detected (and eliminated), appropriate countermeasures can be taken for precluding such a case in the future. The remaining transactions are written into the registry module 30.

A distributed ledger technology as illustrated in FIG. 5 may be utilized to fulfill the requirements described above. A particular realization could be based on a public permissioned blockchain or on a private permissioned blockchain (for less transparency).

If the registry module 30 utilizes a blockchain, the transactions (as listed before) could be stored in conventional databases (e.g., one document store per UDRP 10), in particular databases that are well-protected against any type of data destruction, and the references to the transactions in the different databases could be stored in the blockchain together with a transaction hash as follows:

Reference of the transaction in the blockchain
URI (as a reference to the transaction: e.g., register-db and transaction id)
transaction hash (based on related document in register-db under the given URI)
transaction type
doctype version
meta (for fast processing of transactions)

FIG. 6 illustrates an exemplary process of creating the UDR 1 and integrating the UDR 1 into the UDRE 1000.

The process of creating the UDR 1 and integrating the UDR 1 into the system may comprise the steps of receiving at the UDRP 10 a creation request 2 comprising raw data 21 and creating the UDR 1 based the raw data 21. In addition, the UDRP 10 starts a uniqueness verification process. Depending on the result of the uniqueness verification process the UDRP 10 integrates the UDR 1 into the UDRE 1000 by further processing the UDR 1. In particular, the integration of the UDR 1 may involve creating an encryption key and encrypting the UDR 1, transmitting the encrypted UDR 1 to the storage module 20 and providing UDR creation transaction data to the registry module 30.

In the following, an exemplary embodiment of the creation and integration process is described in further detail.

Receiving the creation request 2 comprising raw data 21 at the UDRP 10 may comprise the following steps. First, a user 54, for instance the uploader 50, starts the management application 500. The management application 500 then waits for user action. The user 54 then selects the raw data 21 and uploads the raw data 21 to the management application 500. For instance, the user may select the raw data 21 in an interface of the management application 500. The management application 500 then sends a request to the user 54 to provide metadata related to the raw data 21 whereupon the user 54 provides metadata to the management application 500.

In the exemplary embodiment, the creation request 2 comprises the raw data 21 and the metadata.

The management application 500 then uploads the creation request 2 comprising the raw data 21 and the metadata to the UDRP 10, in particular to the UDRH 110. In other words, the UDRP 10 receives the creation request 2 comprising the raw data 21 and the metadata.

The UDRH 110 creates the UDR 1 based on the raw data 21 and optionally on the metadata.

The UDRH 110 may prompt the uniqueness verifier 111 to start the uniqueness verification process of the UDR 1, whereupon the uniqueness verifier 111 carries out the uniqueness verification process and provides, optionally, the verification result to the UDRH 110. The UDRH 110 may provide the uniqueness verification result to the management application 500 and the management application 500 may provide the uniqueness verification result to the user 54, for instance, by presenting or displaying the uniqueness verification result on an electronic device of the user 54.

Optionally, in particular in case of a positive uniqueness verification result, e.g. in case the uniqueness verifier found that the UDR 1 is unique, the UDRP 10 may advance with the process of integrating the UDR 1 into the UDRE 1000.

As a first step of the integration process, the UDRP 10 creates an encryption key for the UDR 1. In detail, the management application 500 may request an external key from the user 54. The user 54 then provides the external key to the management application 500 and the management application 500 transfers the external key to the UDRH 110. The UDRH 110 encrypts the UDR 1 with an encryption key. The encryption key is based on the external key and/or on an internal key generated in the UDRP 10. The UDRH 110 then uploads the encrypted UDR to the storage handler 120, whereupon the storage handler 120 answers with an upload notification.

Finally, the UDRH 110 provides the UDR creation transaction data and/or the uniqueness verification transaction data to the registry handler 130, whereupon the registry handler 130 may answer with a success notification after creating the transaction data. The UDRH 110 may then send a success notification to the management application 500 and the management application 500 may provide a success notification to the user 54.

Finally, the UDRH 110 limits access to the raw data 21 used for creating the UDR 1.

In one embodiment, the uniqueness verifier 111 is able to differentiate between various gradations of verification of uniqueness. Before the uniqueness verifier 111 starts verifying, at least one of the uniqueness verification approaches offered by the UDRP 10 must be selected.

The uniqueness verification approach used by the uniqueness verifier 111 can, for example, be selected by the user 54, in particular by the uploader 50, during upload. For instance, the user 54 may select the uniqueness verification approach in the management application 500. Alternatively, the uniqueness verification approach may be selected by the operator of the UDRP 10, e.g. as a default setting for all users. The uniqueness verification approach associated to the UDR 1 may be shown in the registry module 30, e.g. in the uniqueness verification transaction data.

In one embodiment, the uniqueness verification comprises verifying the uniqueness based on a hash of the uploaded digital data, in particular on the raw data 21, on the basis of which the UDR 1 is created, or on the basis of the vulnerable data of the UDR 1. In such an embodiment, it is verified whether the UDR 1 is new to the UDRE 1000 by processing the original digital media file content, e.g. the raw data 21 of the UDR 1, and generating a hash that serves as a fingerprint. Two file hash fingerprints can either be equal or not. In case the hash value of the UDR 1 is found to be equal to a hash value of a UDR 1 already present in the UDRE 1000 or in a specific part of the UDRE 1000, the verification result is negative and the verification result is positive otherwise.

In another embodiment, the uniqueness verification approach is based on the visible/audible content of the UDR 1 as it would be presented; in particular, verification of uniqueness is based on media recognition techniques. In the verification approach based on the content, some other sort of fingerprint may be generated based on the content of the UDR 1. For instance, this fingerprint may be based on image data comprised in the UDR 1 and/or on content detected, e.g. detected by a machine learning program, in image data of the UDR 1. The comparison of two of those fingerprints results in a probability value that indicates a similarity of the two contents. Based on a given probability threshold, the UDR 1 is accepted as unique or not.

In a further embodiment, the verification approach is based on a manual assay provided by subject matter experts. After the upload of the UDR 1, one or more (human) subject matter experts receive a request of the uniqueness verifier 111 to assay the uniqueness of the UDR 1 and to enter the result to the system. The result of the uniqueness verification is based on the entered results.

In yet another embodiment, the verification of uniqueness is based on the metadata associated with the UDR 1. Thus, a UDR 1 may gain its status of uniqueness not only based on the (content of the) raw data 21 of the UDR 1, but, e.g. based on its specific owner, its country of upload or its provenance. In other words, the verification of uniqueness of an UDR 1 may be based on “static” metadata associated with the UDR 1 such as its first owner, its country of first upload, a specific serial number, or on “dynamic” metadata associated with the UDR 1, e.g. its provenance.

In general, the value of the UDR 1 may not only be based on its content, in particular its raw data 21, but also on its individual history, e.g. its history of ownerships and/or presentations, thus, its value may be based on its dynamic metadata. Therefore, having several, even an unlimited amount of copies of the UDR 1 corresponding to the UDR 1 in terms of content in the UDRE 1000 does not necessarily contradict the notion of uniqueness in the context of the UDRE.

In general, the uniqueness verifier 110 may verify the uniqueness of the UDR 1 within the whole UDRE 1000 or only a part of the UDRE 1000. For instance, the uniqueness verification may decide whether the UDR 1 is unique amongst the UDRs belonging to a specific subset of the UDRs within the UDRE 1000. The specific subset may comprise all UDRs belonging to a specific user (e.g. a user may want to know whether he has already uploaded a similar image), all UDRs belonging to a specific group of owners or all UDRs uploaded in a specific location. The uniqueness verifier 111 may be adjustable to verify the uniqueness of a UDR 1 only in a specific part of the UDRE 1000.

In any case, various uniqueness verifier methods should come to the same conclusion when based on the same approach verifying the same digital media independently.

FIG. 7 illustrates an exemplary process of presenting the UDR via a presentation module.

The process of presenting the UDR 1 may comprise the steps of receiving at the UDRP 10 a presentation request, generating seal data, e.g. seal data based on legitimization features, embedding the seal data into the UDR 1 to create a sealed UDR and presenting the sealed UDR on a canvas 43.

In the following an exemplary embodiment of presenting the UDR 1 is described in more detail.

First, the user 54, e.g. the owner 51 of the UDR 1 or a gallerist, initiates the presentation of the UDR 1 via the management application 500.

The management application 500 thereupon sends a get request to the UDRH 110 requesting the list of all UDRs associated with the user 54, e.g. a list containing references to all UDRs owned by the user 54. The UDRH 110 then provides the list to the management application 500.

Furthermore, the management application 500 may send a get request to the UDRH 110 requesting all possible canvases associated with the user 54. The UDRH 110 then provides the list of all those canvases.

The management application 500 provides the list of the UDRs and of canvases to the user 54. The user 54 then selects the UDR 1 to be presented and the canvas 43 where the UDR 1 is to be presented on.

The management application 500 assigns the selected UDR 1 to the selected canvas 43 and informs the UDRH 110 of the assignment.

The UDRH 110 then requests the storage handler 120 to get the encrypted selected UDR 1, whereupon the storage handler 120 downloads the encrypted UDR 1.

The UDRH 110 then decrypts the UDR 1 with its associated encryption key (in case of a symmetric encryption of the UDR 1), which is based on an internal key and/or on an external key.

In order to prepare the sealed UDR 1 for the presentation on the canvas 43, the UDRH 110 provides presentation meta data to the legitimacy handler 160 and requests the legitimacy handler 160 to provide seal data that can be embedded into the UDR 1 to produce the sealed UDR 1. The legitimacy handler 160 thereupon provides the requested seal data to the UDRH 110.

Then, the UDRH 110 provides the seal data and the decrypted UDR 1 to the seal handler 140, whereupon the seal handler 140 embeds the seal data into the decrypted UDR 1 to produce the sealed UDR 1. The seal handler 140 provides the sealed UDR 1 to the UDRH 110.

The UDRH 110 provides the sealed UDR 1 to the (selected) canvas 43. Furthermore, the UDRH 110 provides resulting presentation transaction data to the registry handler 130 for transfer to the registry module 30.

Finally, the UDRH 110 limits access to all local data of the decrypted UDR 1.

In general, access to any encrypted or decrypted local copies of the UDR 1 which are temporarily present in the UDRP 10 is limited, in particular the copies may be automatically deleted, after creation of the sealed UDR 1. Specifically, the UDRP 10 (such as hard drive and cache of the UDRP 10) may delete all local components of the UDR 1, in particular all local components comprising unencrypted or unsealed vulnerable data of the UDR 1, after finishing the process of creating the sealed UDR 1.

In general, the processes of generating the sealed UDR 1 and of presenting the sealed UDR 1 may be executed at different points in time. In particular, the process of presenting the sealed UDR 1 may be executed later than generating the sealed UDR 1. In that case, the step of limiting access to the local data of the decrypted UDR 1 may be executed after the generation of the sealed UDR 1 and before providing the sealed UDR 1 to the canvas 43. Until its presentation, the sealed UDR 1 may be transferred to the storage module 20 or a local copy of the sealed UDR 1 may remain in the UDRP 10.

In general, the seal data may comprise legitimation features and/or a unique, random seal that is generated based on legitimization features (or a token as a representation of those features), e.g., by generating a hash value of the values comprised in the legitimization features. Likewise, a checksum or other appropriate information may be used as a shorter presentation of legitimization features.

Examples of legitimization features comprise a timestamp indicating the starting time of the legitimate presentation, a timestamp indicating the ending time of the legitimate presentation, a geo-location of a legitimate presentation, e.g. a geo-location of the specific unit 41 of the presentation module 40 where the sealed UDR 1 is to be presented, an audio and/or visual representation of the environment of the presentation module 40 (e.g., an image of the surrounding of the presentation module 40).

In addition or alternatively, the seal data may comprise further seal data, e.g. data to identify the UDR 1 or data to identify entries the registry module 30 related to the UDR 1.

In particular, the further seal data may comprise the unique identifier of the UDR 1, a unique identifier of the specific unit of the presentation module 40 (in particular a unique identifier of the selected canvas 43), a unique identifier of the owner 51, and/or a checksum.

The legitimization features are used to validate the specific presentation of the UDR 1. E.g. in case the legitimization features comprise timestamps indicating the starting and ending time of a legitimate presentation, then during the validation process based on a validation request, it may be checked whether e.g. the actual time the validation request is received is in between the starting and ending time indicated in the legitimization features.

Or, in an embodiment where the legitimization features comprise a geo-location of a legitimate presentation, the validation process may involve comparing the geo-location indicated in the legitimization features to the actual geo-location of the presentation of the UDR 1.

The legalization features may further comprise data representing the content of the UDR 1, e.g. via a fingerprint or hash value. Such representation of the content of the UDR 1 may be used to verify whether the extracted seal data correlates with the content of the UDR 1 for which the seal data was generated originally. For instance, by comparing the data representing the content of the UDR 1 with the content of the UDR 1 that the seal data is extracted from. Thus, the data representing the content of the UDR 1 may be used to prevent illegitimately copying seals and transferring them onto a different medium.

The seal data may comprise legitimization features directly, e.g. in an explicit form or as a hashed value. In addition or alternatively, the seal data may comprise legitimization features indirectly, e.g. the seal data may comprise a reference pointer to legitimization features.

In at least one embodiment, the seal data may comprise legitimization features indirectly, e.g. by containing a seal ID, e.g. a unique and random seal, which does not directly reflect any legitimization features. The seal ID may then be used as an “index” (reference pointer) to the UDR 1 or to a registry entry in the registry module 30 where the corresponding legitimization features are stored. During the validation process, the reference pointer may be extracted from the seal data and then, based on the reference pointer, the corresponding legitimization features may be retrieved from the registry module 30 for further checking.

In one embodiment, the seal data is embedded into a copy of the UDR 1, within the metadata of the file, or within the actual image data, in a visible way, for instance, by a QR code, or in an “invisible way”, i.e. in a way nearly unnoticeable by humans, for instance, by using concepts of watermarking and steganography.

The canvas 43 may be coupleable to the UDRP 10 and/or to the management application 500. In particular, in some embodiments, the UDRP 10 may exchange data with and/or send data to the canvas 43 and in some embodiments, the management application may exchange data with and/or send data to the canvas 43.

For example, the canvas 43 may be associated manually to an account of the user 54 in advance (e.g., by logging into a user account on the presentation module 40) or discovered by the management application 500 (e.g., by using local and/or network discovery mechanisms, such as Bluetooth or the Discovery and Launch Protocol DIAL).

FIG. 8 illustrates an exemplary process of validating the legitimacy of a presentation of the UDR.

The validation of the legitimacy of a presentation of the UDR 1 may comprise the steps of receiving, at the UDRP 10, a validation request 3 based on representation data of the presentation of the UDR 1, extracting seal data from the representation data and validating the legitimacy of the presentation of the UDR 1 based on the extracted seal data.

In more detail, in an exemplary embodiment the process of validating the legitimacy of a presentation of the UDR 1 may comprise the following steps.

First, a user 54 may start the validation application 600 whereupon the validation application 600 waits for user action. The validation application 600 may be installed on the smartphone of the user 54.

The user 54 then captures or records the presentation of the UDR 1 and provides the captured data to the validation application 600. The user 54 may capture the presentation of the UDR 1 via a camera and/or microphone of the smartphone, where the validation application 600 is installed on. In particular, the user 54 may capture the presentation of the UDR 1 via the validation application 600, e.g. the validation application 600 may provide a tool to capture the presentation of the UDR 1 and/or provide instructions to the user 54 on how to capture the presentation of the UDR 1 (e.g. to correct a recoding angle or image detail to be captured).

The validation application 600 generates representation data from the captured data provided by the user 54. In particular, the validation application 600 may process the data captured by the user 54 in order to generate the representation data. The processing may involve, compressing or reducing the data captured by the user 54.

The validation application 600 then transfers the representation data to the UDRH 110. The UDRH 110 provides the representation data to the legitimacy handler 160. The legitimacy handler 160 extracts seal data from the representation data.

Alternatively, the extraction of the seal data could also take place within the validation application 600 in order to reduce load on the UDRP 10. In that case, the validation application 600 provides the extracted seal data to the UDRH 110 and the UDRH 110 provides the extracted seal data to the legitimacy handler 160.

The legitimacy handler 160 then validates the presentation of the UDR 1 based on legitimization features. For instance, the legitimacy handler 160 may search in the registry module 30 for the presentation transaction data corresponding to the specific presentation of the UDR 1. A pointer to the relevant presentation transaction data may be comprised in and inferred from the extracted seal data. The registry module 30 may provide the corresponding presentation transaction data (and/or the legitimization features associated with the presentation) to the legitimacy handler 160 and the legitimacy handler 160 may then validate the legitimacy of the presentation of the UDR 1 based on the legitimization features comprised in the presentation transaction data.

In addition or alternatively, the extracted seal data may comprise legitimization features to be used by the legitimacy handler 160 in the validation process directly.

In addition or alternatively, the validation of the presentation of the UDR 1 may comprise the steps of checking whether the extracted seal data was recovered correctly (e.g., by evaluating a checksum) and/or of checking if the legitimization features have been stored in a corresponding transaction in the registry module 30, and/or of checking if the presentation circumstances match the legitimization features (e.g., whether the current time is between start and end of the legitimate presentation and/or whether the geo-location of the validation application 600 and/or the canvas presenting the UDR 1 is close to or corresponds to the legitimate geo-location of the presentation of the UDR 1).

The legitimacy handler 160 then provides the validation result to the UDRH 110 and the UDRH 110 provides the validation result to the validation application 600. Finally, the validation application 600 may show the validation result to the user 54.

Possible results of the validation may comprise data indicating that the extracted seal data is unrecognized (e.g., when the checksum does not match the extracted seal data), that the presentation of the UDR 1 is illegitimate (e.g., when the checksum is correct, but there is no corresponding transaction in the registry module 30 or the validation of the legitimization features failed), or that the presentation of the UDR 1 is legitimate (e.g., when all validation methods succeeded).

FIG. 9 illustrates an exemplary process of retrieving the provenance of the UDR 1 from the registry module 30.

The user 54, e.g. an external person, may request the provenance of the UDR 1 at the UDRP 10.

In an exemplary embodiment, the user 54 directs the request to show the provenance to the validation application 600. The validation application 600 may identify the UDR 1 whose provenance the user 54 requests on the basis of user input in the validation application 600. For example, the validation application 600 may allow the user 54 to choose the UDR 1 via a user interface of the validation application 600.

The validation application 600 thereupon forwards the provenance request to the UDRH 110. The provenance request may comprise data identifying the user 54 and the UDR 1.

The UDRH 110 then checks with the user management system 170 if the access rights of the user 54 to the provenance are OK. The UDRH 110 may provide data identifying the user 54 and optionally data identifying the UDR 1 to the user management system 170.

In case the user management system 170 replies to the UDRH 110 indicating that the access rights are OK, the UDRH 110 directs a request to the registry handler 130 to get the provenance data, i.e. transaction data associated with the UDR 1. The registry handler 130 provides the transaction list comprising the provenance data to the UDRH 110. In particular, the registry handler 130 may load all or a subset of transactions registered for the UDR 1 in the registry module 30 and provide these to the UDRH 110.

The UDRH 110 then provides the provenance data to the validation application 600 and the validation application 600 shows the provenance data to the user 54, e.g. in chronological order.

Alternatively, in case the user management system 170 replies to the UDRH 110 that the access rights of the user 54 are not OK, the UDRH 110 forwards this information to the validation application 600 and the validation application 600 shows an error message to the user 54.

In some embodiments (not depicted here), the provenance of the UDR 1 can be retrieved, i.e. requested and received, by external persons (independently from a user account) and displayed, e.g., in the validation application 600. For example, after validating a legitimate presentation of the UDR 1 the user 54 of the validation application 600 can request the provenance.

FIG. 10 illustrates an exemplary process of transferring the ownership of the UDR 1.

In one embodiment, the process of transferring the ownership of the UDR 1 from a seller, e.g. the (current) owner 51, to a buyer is initiated by the buyer of the UDR 1. In order to gain ownership of the UDR 1, the buyer may be required to have a user account associated with the UDRE 1000.

In a first step, the buyer starts the management application 500, which then waits for user action. The buyer then selects the UDR 1 for purchase in the management application 500 and the management application 500 then marks the UDR 1 as selected.

The buyer then selects at the management application 500 the money transfer type (e.g. credit card, etc.) and assures that all rights have been acquired.

The management application 500 then requests the transfer of ownership of the UDR 1 at the UDRH 110.

The UDRH 110 notifies the seller, e.g. via the management application 500, of the request for transferring the ownership and waits for an approval from the seller.

The approval of the seller of the transfer of ownership and all rights (e.g. copyright etc.) is sent to the UDRP 10 and the seller provides the current external key (the first external key) to the UDRH 110.

The UDRH 110 request the encrypted UDR 1 from the storage handler 120, whereupon the storage handler 120 downloads the encrypted UDR 1 and provides it to the UDRH 110.

The UDRH 110 decrypts the encrypted UDR 1 with a first encryption key based on a first internal key and/or on the first external key.

The UDRH 110 requests a second (new) external key from the management application 500 and the management application 500 requests the second external key from the buyer. The buyer then provides the second external key to the management application 500 and the management application 500 forwards the second external key to the UDRH 110. The buyer may decide not to provide a second external key.

The UDRH 110 encrypts the decrypted UDR 1 with a second encryption key. The second encryption key may be based on a new internal key, which in general is different from the first internal key, and/or on the second external key.

The UDRH 110 then uploads the newly encrypted UDR 1, i.e. the UDR 1 encrypted with the second encryption key, to the storage hander 120. The storage handler may then upload the encrypted UDR 1 to a unit of the storage module 20 that is selected by the buyer. The storage handler 120 replies to the UDRH 110 with an upload notification.

Furthermore, the UDRH 110 requests a deletion of the UDR 1 encrypted with the (old) first encryption key. The storage handler 120 may then initiate the deletion of the encrypted UDR. The storage handler 120 then replies with a deletion notification (e.g. after the deletion is confirmed by the storage module 20).

After the encryption of the UDR 1 with the second encryption key, the UDRH 110 limits access to, in particular deletes irrevocably, all local data of the (unencrypted) UDR 1. Furthermore, the UDRH 110 may delete the first internal key and/or the first encryption key in the UDRP 10. Thus, even if the deletion of the UDR 1 encrypted with the first encryption key in the storage module 20 failed, —at least in case the generation of the first encryption key required the first internal key—the first external key becomes useless as the first internal key of the UDR 1 (which was only known to the UDRP 10) is deleted and consequently the first encryption key cannot be reconstructed.

Finally, the UDRH 110 adds data related to the ownership transfer to the registry module 30. In particular, the UDRH 110 forwards data associated with the ownership transfer to the registry handler 130 and the registry handler 130 generates transfer of ownership transaction data which is then stored in the registry module 30.

The UDRH 110 sends a success notification to the management application 500 and to the seller and the management application 500 provides the success notification to the buyer.

In this respect, the transfer of ownership is a process similar to the process of retrieval from the storage module 20 followed by the new creation and integration of the UDR 1.

Alternatively, the process of transfer of ownership may be initiated by the seller. In that case, the seller informs the UDRP 10 via the management application 500 of the offered transfer of ownership. The UDRP 10 then informs a potential buyer, about the transfer request of the UDR 1. The transfer request then needs to be approved by the potential buyer. The process then continues as described above.

FIG. 11 illustrates a sealed UDR as the result of embedding seal data into a UDR.

In order to be able to trace the legitimacy of a presentation of the UDR 1, seal data 41, e.g. a token, is generated for each presentation. The seal data 41 is then embedded into the UDR 1 to produce a sealed UDR 4. As illustrated in FIG. 11, the sealed UDR 4 may in general appear very similar to the unsealed, original UDR 1.

In an exemplary embodiment, the process of embedding seal data may involve a step of extracting and/or modifying data of the UDR 1 suitable for the embedding. For instance, the process of embedding the seal data may involve extracting data related to a specific color channel of image and/or video data or a specific audio channel or frequency range of audio data.

In general, the embedding of the seal data may affect only one or more parts of the UDR 1, in particular different data parts of the UDR 1 may be affected in a different way. For instance, the process of embedding the seal data may only affect a specific color channel of image and/or video data or a specific audio channel or frequency range of audio data.

For instance, the procedure of embedding seal data into image data of the UDR 1 may be based on the Cb color channel and \ or the Cr color channel, because these channels are comparatively stable for encoding and it is quite hard for the human eye to spot small changes in these channels.

Alternatively or in addition, the UDR 1, or specifically extracted data from the UDR 1, may be modified, in particular scaled, in order to be suitable for the seal embedding procedure. The scaling of the data may be based on one or more applications of one or more transformations (such as the discrete wavelet transformation, discrete Fourier transformation and/or the discrete cosine transformation). In particular, the scaling of the data may require a single or a repeated, in particular an accumulated, application of the transformations.

The particular scaling process chosen may depend on the UDR 1. For instance, the process of embedding seal data may require the input data of the embedding process to be of a specific size. In order to reach the specific size needed for the embedding procedure, a scaling procedure may be applied to the UDR 1 to meet the requirements before an actual modification, i.e. an actual embedding of the seal data, is carried out.

The size of the scaled down data may be determined by a threshold, in particular, the data might be scaled down to a size lower than a threshold.

In an exemplary embodiment, the seal data is embedded in the UDR 1 in a way that the alterations caused by the embedding of the seal data are not readily perceptible by humans when the sealed UDR 4 is presented. At the same time, the alterations caused by the embedding may be recognizable by a device that has access (e.g. visual access via a camera system) to the presentation of the sealed UDR 4.

Such a non-perceivable embedding of seal data may be generated by embedding the seal data into parts of the UDR 1 comprising data whose (minor) alteration is not easily perceived by humans (such as a specific color or frequency range).

The final preparation of a presentation of the sealed UDR 4 may require the UDRP 10 to restore the size of the data. Optionally, the UDRP 10 may further alter the sealed UDR 4 to prepare it for the presentation. For instance, in case the presentation of the sealed UDR 4 involves the display of an image, one or more borders may be added to the image, for instance a white border and a blue border, so that a recording or a picture of the presentation of the sealed UDR 4 can be easily cropped.

In the exemplary embodiment shown in FIG. 11, the UDR 1 comprises digital image data comprising YCbCr (Luminance, Chrominance Blue and Chrominance Red) color channels and the seal data 41, e.g. in form of a token, comprises a message represented in 16 bytes. The message may reference legitimization features related to a presentation of the UDR 1.

However, the size of 16 bytes is only one example of a possible size of the message and the person skilled in the art will easily adapt the subsequently described procedure to accommodate seal data 41 comprising a message of a different size.

The procedure of embedding the seal data 41 into the image data is based on the Cb color channel and/or the Cr color channel and in preparation for the embedding procedure the data of the color channel is scaled down.

The size of the scaled down image data may be determined by a threshold value and/or by a scaling factor. For instance, given image data of size 1920×1080, the threshold size may be set to 192×128 pixels, i.e. in order to embed the seal data 41, the image data may be reduced by a scaling factor of approximately 100.

In an exemplary embodiment, the process of scaling down image data comprises a single or a repeated, in particular an accumulated, application of a discrete wavelet transform (DWT). Each application of the DWT reduces the size of its input data to about half of the size. Thus, by a repeated application of a DWT, the image data can be reduced to be lower than a desired threshold size.

The process of scaling down may not produce the exact threshold size as desired, but only provide an approximate estimation of the size of the scaled down image. For instance, it may be sufficient that the size of the scaled down image is in the same order of magnitude as the threshold.

For instance, if the threshold size is set to 192×128 pixels, reducing the size of the image data to a 240×135-pixel representation of the image may be sufficient.

The original image can be reconstructed from the DWT-result together with high- and low-pass filter information.

In a next step, the image data, in particular the downscaled image data is split into image tiles, each containing a different information of the image. For instance, an image downscaled to 192×128 pixels may be split into six image tiles, each comprising 64×64 pixels.

In a further step, each image tile is split into blocks of pixels. For instance, each image tile is split into blocks of 8×8 pixels.

For each of the blocks, a discrete cosine transformation is applied. In other words, each block is represented as a combination of different spectral coefficients, where the spectral coefficients are associated with specific frequency ranges of the image.

Mid-frequencies have the property that they can only be perceived with difficulty by humans and still are robust against different spectral disorders. Thus, mid-frequencies may be used to encode the seal data 41, e.g. by manipulating the spectral coefficients associated with mid-range frequencies.

In an exemplary embodiment, the seal data 41 comprises a message which is converted into a binary string. For instance, a 16 Byte message may be converted into a binary string (with a length of 128 Bit=01001111 . . . ). Then the message may be encoded in the spectral coefficients associated with the mid-frequencies as described below.

In an exemplary embodiment, the encoding of the message in the spectral coefficients is based on building coefficient pairs.

For instance, based on four transformation coefficients two pairs of coefficients may be built (as if a left value and right value were present). However, also other numbers of pairs of coefficients are possible.

A procedure of embedding the seal data 41 into the image data is based on comparing the values of the coefficient pairs with each other and swapping and possibly adjusting the values based on values of the bits in the message.

The embedding may be such, that each coefficient pair is used for the encoding of exactly one given bit of the message.

To illustrate, let “matrix” denote a DCT transformed 8×8 block. In other words, the 8×8 matrix called “matrix” contains the coefficients that resulted from transforming an 8×8 block of one of the image tiles. In detail, let matrix[i][j] denote the coefficient in the i-th row and in the j-th column of the matrix “matrix”, where i and j are natural numbers between 0 and 7. The coefficients in the “middle”, i.e. matrix[i][j] where i and j are numbers between 3 and 5 correspond to midrange frequencies.

The first pair of coefficients contains the values matrix[4][3] and matrix [3][4] and the second pair of coefficients contains the values in matrix [5][3] and matrix [3][5].

In an exemplary embodiment, the values of the first coefficient pair matrix[4][3] and matrix [3][4] are manipulated based on the following rules:

If the given bit is “1”: the value matrix[4][3] should be bigger than the value matrix[3][4]. If this criterion is not satisfied, the values of matrix[4][3] and matrix[3][4] are swapped.

The other way around goes for the case when the given bit is “0”: the value in matrix[4][3] has to be smaller than matrix[3][4]. If not, the two values are swapped.

In addition, for robustness, in either case the value that has to be larger than the other one may be increased by a predetermined value, for instance by a fixed value, e.g. 200. Alternatively, the predetermined value can be determined individually, e.g. based on the frequencies comprised in the image content. In general, the higher the frequencies, the more severe modifications are necessary to achieve the desired robustness.

The just described swapping-procedure for the coefficient pair matrix[3][4] and matrix[4][3] encodes one given bit of the message in an 8×8 block of pixel data.

In general, by applying a similar swapping procedure to a coefficient pair, one bit of a message can be encoded. In particular, by applying a similar swapping procedure to the values of the second coefficient pair matrix[5][3] and matrix[3][5], and optional adjustment of the higher value, another given bit of the message can be encoded into the same block.

It is understood, that the swapping procedure can be applied also to other coefficient pairs and that the instructions for encoding a bit “0” and a bit “1” can be different, in particular, the instructions can be exchanged. It is also understood that the procedure can be adjusted to spectral coefficients obtained by applying an appropriate transform to differently sized blocks, for instance for blocks of size 4×4 or blocks of size 16×16.

Via the swapping-procedure just described two bits of the message are encoded in every 8×8 block. So the encoding of a 128 bit-long message requires 64 blocks. Therefore, the procedure may be smoothly applied having image tiles of 8×8 blocks since it allows exactly one encoding of the message per image tile.

If the image data has been split into several tiles, the same procedure as described above may be applied to the other tiles as well. Thus, the message may be encoded several times in the same image. For instance, in case the image is split into six image tiles, six encodings of the message in one image may be realized. The multitude of encodings of the same message may result in better accuracy in the decoding of the message.

In a final step, the sealed UDR 4 is restored by applying a reverse DCT to the respective blocks and then the reverse DWTs as often as needed to receive the picture with the original resolution.

Optionally, one or more borders may be added to the sealed UDR 4, for instance a white border and a blue border, so that a recording or a picture of the presentation of the sealed UDR 4 can be easily cropped.

FIG. 12 illustrates the process of validating the presentation of the UDR in the case where the presentation of the UDR is based on image data.

In the exemplary embodiment illustrated in FIG. 12, a visual presentation of the sealed UDR 4, e.g. obtained by the procedure described with reference to FIG. 11, comprises at least one displayed image. For preparing representation data 31 of the displayed sealed UDR 4, a camera 70 is used that produces high-quality digital pictures as known from current smart phones. Seal data 42 is then extracted from the representation data 31 via a decoder 80. The decoder 80 may be part of the UDRP 10 and/or of the validation application 600.

Since captured media does not represent the original media, it may be manipulated in many ways. Therefore, in order to minimize errors, in an exemplary embodiment, seal data is extracted separately from several images comprised in the representation data 31 and then the final output, that is the extracted seal data 42, is determined based on the seal data extracted from the separate images.

In an exemplary embodiment, a short video, e.g. an approximately 5 seconds long video, of the presentation of the sealed UDR 4 is captured with the camera 70. Alternatively, one or more images captured from the presentation of the sealed UDR 4 with the camera 70 may also be used.

The video is then divided into frames. For instance, after the division the number of frames might be between 22 and 26.

In a next step, the corners of the image in every frame are detected, for instance by using borders that have been added in the encoding phase to the sealed UDR 4, and perceptual restoration of the image is applied, e.g. a distortion or a discoloration of the image is corrected.

The seal data, e.g. a token (as described with reference to FIG. 11), is extracted (e.g. by the decoder 80) from each (cropped) frame, or each image, separately. For instance, dividing the video into 22 frames, where each frame comprises 6 encodings (as described above) of the token, results in a total of 22×6=132 decodings of the bit stream token.

The final output, i.e. the extracted seal data 42 can be produced by a majority vote for every bit. For instance, if according to the majority of the decodings the value of the n-th bit of the extracted token is i (where i is either 0 or 1) then the final output for the n-th bit of the extracted seal data 42 is also i.

In order to minimize problems with images where the black color or the white color dominates, a specific camera 70 may be used that does not distort that much the black and white colors.

In addition or alternatively, the decoder 80 may be made more robust e.g., by having a different algorithm for black and white colors, respectively, and/or e.g. by depending on the content switch between different color inputs to be manipulated.

The decoder 80, which extracts the seal data, may be implemented as a server-side process or as a client framework (e.g., for an iOS App or an Android App).

Furthermore, the disclosure relates to the following embodiments:

Embodiment 1: Method for managing at least one unique data record (1), in particular a digital work of art, at a unique data record platform (10) comprising the following steps:
receiving at the unique data record platform (10) a creation request (2) comprising raw data (21);
creating, at the unique data record platform (10), the unique data record (1) based on the raw data (21);
verifying the uniqueness of the unique data record (1) within at least a part of a unique data record ecosystem (1000) comprising the unique data record platform (10) and/or at least one module (20, 30, 40) associated with it;
integrating, at the unique data record platform (10), the unique data record (1) into the unique data record ecosystem (1000) on the basis of the uniqueness verification process; and
automatically limiting access to the raw data (21) used for creating the unique data record (1) in the unique data record platform (10).

Embodiment 2: Method according to embodiment 1, wherein limiting access to the raw data (21) is based on modifying the raw data (21).

Embodiment 3: Method according to embodiment 2, wherein modifying the raw data is based on overwriting, deleting, irreversibly alter, and/or scrambling the raw data (21).

Embodiment 4: Method according to any of the previous embodiments, wherein creating the unique data record (1) is based on processing, in particular extracting, data from the raw data (21).

Embodiment 5: Method according to any of the previous embodiments, wherein creating the unique data record (1) is based on modifying the data format of the raw data (21).

Embodiment 6: Method according to any of the previous embodiments, wherein the creation request (2) comprises metadata associated with the raw data (21).

Embodiment 7: Method according to embodiment 6, wherein the creation of the unique data record (1) is based on the metadata.

Embodiment 8: Method according to any of the previous embodiments, wherein verifying the uniqueness of the unique data record (1) is based on comparing the unique data record (1) with one or more unique data records already present in the unique data record ecosystem (1000).

Embodiment 9: The method according to embodiment 8, wherein the comparison is based on the content of the unique data record (1) and/or on the metadata associated with the unique data record (1).

Embodiment 10: Method according to at least one of the previous embodiments, comprising the step of processing, at the unique data record platform (10), the unique data record (1) on the basis of condition data.

Embodiment 11: Method according to embodiment 10, wherein the step of processing is based on processing request data, in particular request data comprising the condition data, received at the unique data record platform (10).

Embodiment 12: Method according to embodiment 10 or embodiment 11, wherein processing comprises encrypting at least a first subset of the unique data record (1) to produce an encrypted unique data record (1).

Embodiment 13: Method according to embodiment 12, wherein the condition data comprises a key on the basis of which the unique data record platform (10) encrypts the at least first subset of the unique data record (1).

Embodiment 14: Method according to embodiment 12 or 13, wherein processing comprises transmitting the encrypted unique data record (1) to a storage module (20) coupleable to the unique data record platform (10).

Embodiment 15: Method according to at least one of the embodiments 12 to 14, wherein processing comprises retrieving, at the unique data record platform (10), the encrypted unique data record (1) from the storage module (20).

Embodiment 16: Method according to at least one of the embodiments 10 to 15, wherein processing comprises automatically limiting access, at the unique data record platform (10), to the unique data record (1).

Embodiment 17: Method according to embodiment 16, wherein limiting access to the unique data record (1) is based on modifying the unique data record (1), in particular on modifying an unencrypted subset of the unique data record.

Embodiment 18: Method according to embodiment 17, wherein modifying is based on overwriting, deleting, irreversibly alter, and/or scrambling the unique data record (1).

Embodiment 19: Method according to at least one of the embodiments 10 to 18, wherein processing comprises embedding seal data (41) into the unique data record (1) to produce a sealed unique data record (4).

Embodiment 20: Method according to embodiment 19, wherein the seal data (41) is associated with a presentation of the unique data record (1).

Embodiment 21: Method according to embodiment 19 or embodiment 20, wherein the seal data (41) is generated based on information contained in the condition data.

Embodiment 22: Method according to at least one of the embodiments 19 to 21, wherein the seal data (41) references and/or comprises legitimization features, in particular one or more geo-locations and/or one or more time periods, associated with the presentation of the unique data record (1).

Embodiment 23: Method according to at least one of the embodiments 19 to 22, wherein the embedding of the seal data (41) is based on manipulating at least a subset of the unique data record (1).

Embodiment 24: Method according to embodiment 23, wherein the subset of the unique data record (1) is based on data of a specific frequency range.

Embodiment 25: Method according to embodiment 23 or embodiment 24, wherein the subset of the unique data record (1) is chosen based on the content of the subset of the unique data record (1).

Embodiment 26: Method according to at least of the previous embodiments, wherein the unique data record (1) comprises image data.

Embodiment 27: Method according to embodiment 26, wherein the embedding of the seal data (41) is based manipulating pixel data, in particular pixel data of a specific frequency range and/or a specific color channel, of the image data.

Embodiment 28: Method according to embodiment 27, wherein pixel data associated with spectral coefficients associated with mid-range frequencies is manipulated.

Embodiment 29: Method according to at least one of the embodiments 26, wherein the manipulated pixel data is determined based on the image content.

Embodiment 30. Method according to at least one of the previous embodiments, wherein the unique data record (1) comprises audio data.

Embodiment 31: Method according to embodiment 30, wherein the embedding of the seal data (41) is based manipulating the audio data of a specific frequency range.

Embodiment 32: Method according to embodiment 31, wherein the specific frequency range is a frequency range that is inaudible by humans.

Embodiment 33. Method according to at least one of the embodiments 19 to 32, wherein processing comprises transmitting the unique data record (1), in particular the sealed unique data record (4) to a presentation module (40) comprising means to present, in particular to display or play back, a presentation of the unique data record (1).

Embodiment 34: Method according to at least one of the previous embodiments, comprising the step of transmitting metadata, in particular transaction data, associated with the unique data record (1) to a registry module (30) coupleable to the unique data record platform (10).

Embodiment 35: Method according to at least one of the previous embodiments, comprising the step of retrieving metadata, in particular transaction data, associated with the unique data record (1) from the registry module (30).

Embodiment 36: Method according to at least one of the previous embodiments, wherein the unique data record ecosystem (1000) comprises a plurality of unique data record platforms (10) and/or a plurality of modules (20, 30, 40).

Embodiment 37: Method for validating at a unique data record platform (10) and/or at a validation application (600) a presentation of a unique data record (1), in particular a digital work of art, generated with a method according to at least one of the embodiments 1 to 36 comprising the following steps:
receiving, at the unique data record platform (10) and/or at the validation application (600), a validation request (3) for validating the presentation of the unique data record (1) based on representation data (31) of the presentation of the unique data record (1); and
validating the presentation of the unique data record (1) based on extracted seal data (42), in particular on legitimization features comprised in and/or referenced by the extracted seal data, extracted from the representation data (31).

Embodiment 38: Method according to embodiment 37, wherein the representation data (31) comprises captured data of the presentation of the unique data record (1).

Embodiment 39: Method according to embodiment 37 or embodiment 38, wherein the representation data (31) comprises visually recorded image data of the presentation of the unique data record (1).

Embodiment 40: Method according to at least one of the embodiments 37 to 39, wherein the representation data (31) comprises audio data, in particular acoustically recorded audio data, of the presentation of the unique data record (1).

Embodiment 41: Method according to at least one of the embodiments 37 to 40, wherein the extracted seal data (42) is extracted at the unique data record platform (10).

Embodiment 42: Method according to at least one of the embodiments 37 to 41, wherein the extracted seal data (42) is extracted at the validation application (600).

Embodiment 43: Method according to at least one of the embodiments 37 to 42, wherein validating is performed at least in part by comparing the extracted seal data (42) with presentation transaction data associated with the presentation of the unique data record (1).

Embodiment 44: Method according to embodiment 43, wherein the presentation transaction data associated with the presentation of the unique data record (1) is retrieved from a registry module (30) coupleable to the unique data record platform (10) and/or to the validation application (600).

Embodiment 45: Method according to at least one of the embodiments 37 to 44, comprising the step of, at the unique data record platform (10), embedding seal data (41) into the unique data record (1) to produce a sealed unique data record (4).

Embodiment 46: Method according to embodiment 45, comprising the step of transmitting the sealed unique data record (4) to a presentation module (40) comprising means to display a presentation of the unique data record (1).

Embodiment 47: System for managing at least one unique data record (1), in particular a digital work of art, at a unique data record platform (10) comprising
a receiving means, at the unique data record platform (10) for receiving a creation request (2) comprising raw data (21);
a processing means, at the unique data record platform (10), for creating the unique data record (1) based on the raw data (21);
a verification means, at the unique data record platform (10), for verifying the uniqueness of the unique data record (1) within at least a part of a unique data record ecosystem (1000) comprising the unique data record platform (10) and/or at least one module (20, 30, 40) associated with it,
integrating means, at the unique data record platform (10), to integrate the unique data record (1) into the unique data record ecosystem (1000) on the basis of the uniqueness verification process;
and
an access control means for automatically limiting access to the raw data (21) for creating the unique data record (1) in the unique data record platform (10).

Embodiment 48: System for validating at a unique data record platform (10) and/or at a validation application (600) a presentation of a unique digital data record (1), in particular a digital work of art, generated with a method according to at least one of the embodiments 1 to 36 comprising a receiving means, at the unique data record platform (10) and/or at the validation application (600), for receiving a validation request (3) based on representation data (31) of the presentation of the unique data record (1); and a validation means, at the unique data record platform (10) and/or at the validation application (600), for validating the presentation of the unique data record (1) based on extracted seal data (42), in particular on legitimization features comprised in and/or referenced by the extracted seal data, extracted from the representation data (31).

Embodiment 49: A computer program product comprising portions of program code which when executed by one or more processors cause the one or more processors to execute the method according to at least one of the embodiments 1 to 36 or 37 to 46.

### REFERENCE NUMBERS

1 unique data record (UDR)
2 creation request
21 raw data
3 validation request
31 representation data
4 sealed UDR
41 seal data
42 extracted seal data
10 unique data record platform (UDRP)
110 unique data record handler (UDRH)
111 uniqueness verifier
20 storage module
120 storage handler
30 registry module
130 registry handler
40 presentation module
43 canvas
140 seal handler
160 legitimacy handler
170 user management system
500 management application
600 validation application
50 uploader
51 owner
52 external person
53 potential buyer
54 user
70 camera
80 decoder
1000 unique data record ecosystem (UDRE)

1. A method for managing at least one unique data record, in particular a digital work of art, at a unique data record platform comprising the following steps:
receiving at the unique data record platform a creation request comprising raw data;
creating, at the unique data record platform, the unique data record (based on the raw data;
verifying the uniqueness of the unique data record within at least a part of a unique data record ecosystem comprising the unique data record platform and/or at least one module associated with it;
integrating, at the unique data record platform, the unique data record into the unique data record ecosystem on the basis of the uniqueness verification process; and
automatically limiting access to the raw data used for creating the unique data record in the unique data record platform.

2. The method according to claim 1, wherein limiting access to the raw data is based on modifying the raw data.

3. (canceled)

4. The method according to claim 1, wherein creating the unique data record is based at least one of
on processing, in particular extracting, data from the raw data, and
on modifying the data format of the raw data.

5. (canceled)

6. The method according to claim 1, wherein the creation request comprises metadata associated with the raw data.

7. (canceled)

8. (canceled)

9. (canceled)

10. The method according to claim 1, comprising the step of processing, at the unique data record platform, the unique data record on the basis of condition data.

11. (canceled)

12. The method according to claim 10, wherein processing comprises at least one of
encrypting at least a first subset of the unique data record to produce an encrypted unique data record,
transmitting the encrypted unique data record to a storage module coupleable to the unique data record platform and
retrieving, at the unique data record platform, the encrypted unique data record from the storage module.

13. (canceled)

14. (canceled)

15. (canceled)

16. The method according to claim 10, wherein processing comprises automatically limiting access, at the unique data record platform, to the unique data record.

17. (canceled)

18. (canceled)

19. The method according to claim 10, wherein processing comprises embedding seal data into the unique data record to produce a sealed unique data record.

20. (canceled)

21. (canceled)

22. The methed according to claim 19, wherein the seal data references and/or comprises legitimization features, in particular one or more geo-locations and/or one or more time periods, associated with the presentation of the unique data record.

23. The method according to claim 19, wherein the embedding of the seal data is based on manipulating at least a subset of the unique data record.

24. (canceled)

25. (canceled)

26. The method according to claim 1, wherein the unique data record comprises at least one of image data and audio data.

27. (canceled)

28. (canceled)

29. (canceled)

30. (canceled)

31. (canceled)

32. (canceled)

33. (canceled)

34. The method according to claim 1, comprising at least one of
the step of transmitting metadata, in particular transaction data, associated with the unique data record to a registry module coupleable to the unique data record platform, and
the step of retrieving metadata, in particular transaction data, associated with the unique data record from the registry module.

35. (canceled)

36. (canceled)

37. The method for validating at a unique data record platform and/or at a validation application a presentation of a unique data record, in particular a digital work of art, generated with a method according claim 1 comprising the following steps:
receiving, at the unique data record platform and/or at the validation application, a validation request for validating the presentation of the unique data record based on representation data of the presentation of the unique data record; and
validating the presentation of the unique data record based on extracted seal data, in particular on legitimization features comprised in and/or referenced by the extracted seal data, extracted from the representation data.

38. The method according to claim 37, wherein the representation data comprises at least one of
captured data of the presentation of the unique data record,
visually recorded image data of the presentation of the unique data record and
audio data, in particular acoustically recorded audio data of the presentation of the unique data record.

39. (canceled)

40. (canceled)

41. The method according to claim 37, wherein the extracted seal data is extracted at least one of
at the unique data record platform and
at the validation application.

42. (canceled)

43. The method according to claim 37, wherein validating is performed at least in part by comparing the extracted seal data with presentation transaction data associated with the presentation of the unique data record.

44. (canceled)

45. (canceled)

46. (canceled)

47. A System for managing at least one unique data record, in particular a digital work of art, at a unique data record platform comprising
a receiving means, at the unique data record platform for receiving a creation request comprising raw data;
a processing means, at the unique data record platform, for creating the unique data record based on the raw data;
a verification means, at the unique data record platform, for verifying the uniqueness of the unique data record within at least a part of a unique data record ecosystem comprising the unique data record platform and/or at least one module associated with it,
integrating means, at the unique data record platform, to integrate the unique data record into the unique data record ecosystem on the basis of the uniqueness verification process;
and
an access control means for automatically limiting access to the raw data for creating the unique data record in the unique data record platform.

48. A system for validating at a unique data record platform and/or at a validation application a presentation of a unique digital data record, in particular a digital work of art, generated with a method according to claim 1 comprising
a receiving means, at the unique data record platform and/or at the validation application, for receiving a validation request based on representation data of the presentation of the unique data record; and
a validation means, at the unique data record platform and/or at the validation application, for validating the presentation of the unique data record based on extracted seal data, in particular on legitimization features comprised in and/or referenced by the extracted seal data, extracted from the representation data.

49. A computer program product comprising portions of program code which when executed by one or more processors cause the one or more processors to execute the method according to claim 1.

50. A computer program product comprising portions of program code which when executed by one or more processors cause the one or more processors to execute the method according to claim 37.
